(19) United States
(12) Patent Application Publication
(10) Pub. No.: US 2026/0135583 A1
(43) Pub. Date: May 14, 2026

(54) ANTENNA FOR WIDEBAND TERAHERTZ (THZ) LINK

(71) Applicant: Attotude, Inc., Menlo Park, CA (US)

(72) Inventors: Philip Kness, Boise, ID (US); David F. Welch, Atherton, CA (US); Joy Laskar, Mountain View, CA (US)

(21) Appl. No.: 19/176,904

(22) Filed: Apr. 11, 2025

Related U.S. Application Data
(60) Provisional application No. 63/720,531, filed on Nov. 14, 2024.

(51) Int. Cl. H04B 1/40; H01Q 9/04; H01Q 11/08; H01Q 13/06; H01Q 13/10; H01Q 21/06

(52) U.S. Cl. CPC H04B 1/40; H01Q 9/0407; H01Q 11/08; H01Q 13/06; H01Q 13/10; H01Q 21/065

(57) ABSTRACT

Transmitters, receivers, transceivers, transport networks, and methods of use are described herein, including a transmitter comprising a client-side input, transmitter circuitry, and antennas. The client-side input receives baseband signals having client data encoded therein. The transmitter circuitry receives the baseband signals from the client-side input and generates antenna feed signals based on the baseband signals. The antennas receive the antenna feed signals from the transmitter circuitry, generate radiated signals based on the antenna feed signals, and couple the radiated signals into hollow waveguides. The radiated signals are radiated electromagnetic waves configured for coherent detection and having one or more frequencies in a range between 300 Gigahertz (GHz) and 10 Terahertz (THz). The antennas include one of a helical antenna, a waveguide probe antenna, a tapered antenna, a patch antenna, and a slot antenna.

### REFERENCE TO RELATED APPLICATIONS

The present application claims priority to the provisional application identified by U.S. Ser. No. 63/720,531, filed on Nov. 14, 2024. The entire content of U.S. Ser. No. 63/720,531 is hereby incorporated herein by reference.

### BACKGROUND ART

Optical networking is a means of communication that uses signals encoded in light to transmit information in various types of telecommunications networks, including limited range local-area networks (LANs) or wide-area networks (WANs). It is a form of optical communication that relies on optical amplifiers, lasers, or LEDs and wavelength-division multiplexing (WDM) to transmit large quantities of data, generally across fiber-optic cables. Because it is capable of achieving extremely high bandwidth, it is an enabling technology for the Internet and telecommunication networks that transmit the vast majority of all human and machine-to-machine information. However, further development and optimization of optical networking systems face certain limiting factors, namely, power dissipation, thermal requirements, and mechanical tolerances.

Optical components generate photons by exciting electrons in a gain medium, and the electrons emit photons as they return to lower energy levels. Despite efforts to improve efficiency, optical components generate some amount of heat during the electron excitation process, and such heat is referred to as power dissipation. Excessive power dissipation may lead to thermal management problems and may affect the performance and longevity of the optical components.

Optical components are sensitive to temperature fluctuations and often require lower operating temperatures than purely electronic components to maintain optimal performance. Elevated temperatures may result in increased signal noise, diminished signal quality, and reduced service life for optical components. Accordingly, optical components often require cooling systems (e.g., heat sinks, fans, or thermoelectric devices) to dissipate excess heat and maintain the optical components within a safe temperature range.

Optical networking systems typically operate in micrometer wavelengths, demanding extreme precision in component fabrication, assembly, and alignment. Even slight deviations from the required mechanical tolerances may lead to signal degradation, loss, or the introduction of optical crosstalk, negatively impacting network performance. Achieving and maintaining the necessary mechanical tolerances necessitates advanced manufacturing techniques and stringent quality control measures.

Terahertz (THz) wireless communications in a frequency range between 300 Gigahertz (GHz) and 10 THz offer the potential for extremely high data rates, but face significant technical challenges. Existing approaches for transmitting and receiving dual-polarized THz signals have relied heavily on optical components, increasing complexity, cost, and power consumption.

### SUMMARY

The problems existing in the field of optical networking are solved by the systems, assemblies, and methods disclosed herein.

In a first aspect, the present disclosure includes a transmitter, comprising: a client-side input configured to receive one or more baseband signals having client data encoded therein; transmitter circuitry configured to receive the one or more baseband signals from the client-side input and generate one or more antenna feed signals based on the one or more baseband signals; and one or more antennas configured to receive the one or more antenna feed signals from the transmitter circuitry, generate one or more radiated signals based on the one or more antenna feed signals, and couple the one or more radiated signals into one or more hollow waveguides, the one or more radiated signals being radiated electromagnetic waves configured for coherent detection and having one or more frequencies in a range between 300 Gigahertz (GHz) and 10 Terahertz (THz); wherein each particular antenna of the one or more antennas is a helical antenna.

In a second aspect, the present disclosure includes a transmitter, comprising: a client-side input configured to receive one or more baseband signals having client data encoded therein; transmitter circuitry configured to receive the one or more baseband signals from the client-side input and generate one or more antenna feed signals based on the one or more baseband signals; and one or more antennas configured to receive the one or more antenna feed signals from the transmitter circuitry, generate one or more radiated signals based on the one or more antenna feed signals, and couple the one or more radiated signals into one or more hollow waveguides, the one or more radiated signals being radiated electromagnetic waves configured for coherent detection and having one or more frequencies in a range between 300 Gigahertz (GHz) and 10 Terahertz (THz); wherein each particular antenna of the one or more antennas is a waveguide probe antenna.

In a third aspect, the present disclosure includes a transmitter, comprising: a client-side input configured to receive one or more baseband signals having client data encoded therein; transmitter circuitry configured to receive the one or more baseband signals from the client-side input and generate one or more antenna feed signals based on the one or more baseband signals; and one or more antennas configured to receive the one or more antenna feed signals from the transmitter circuitry, generate one or more radiated signals based on the one or more antenna feed signals, and couple the one or more radiated signals into one or more hollow waveguides, the one or more radiated signals being radiated electromagnetic waves configured for coherent detection and having one or more frequencies in a range between 300 Gigahertz (GHz) and 10 Terahertz (THz); wherein each particular antenna of the one or more antennas is a tapered antenna.

In a fourth aspect, the present disclosure includes a transmitter, comprising: a client-side input configured to receive one or more baseband signals having client data encoded therein; transmitter circuitry configured to receive the one or more baseband signals from the client-side input and generate one or more antenna feed signals based on the one or more baseband signals; and one or more antennas configured to receive the one or more antenna feed signals from the transmitter circuitry, generate one or more radiated signals based on the one or more antenna feed signals, and couple the one or more radiated signals into one or more hollow waveguides, the one or more radiated signals being radiated electromagnetic waves configured for coherent detection and having one or more frequencies in a range between 300 Gigahertz (GHz) and 10 Terahertz (THz); wherein each particular antenna of the one or more antennas is a patch antenna.

In a fifth aspect, the present disclosure includes a transmitter, comprising: a client-side input configured to receive one or more baseband signals having client data encoded therein; transmitter circuitry configured to receive the one or more baseband signals from the client-side input and generate one or more antenna feed signals based on the one or more baseband signals; and one or more antennas configured to receive the one or more antenna feed signals from the transmitter circuitry, generate one or more radiated signals based on the one or more antenna feed signals, and couple the one or more radiated signals into one or more hollow waveguides, the one or more radiated signals being radiated electromagnetic waves configured for coherent detection and having one or more frequencies in a range between 300 Gigahertz (GHz) and 10 Terahertz (THz); wherein each of the one or more antennas is a slot antenna.

In a sixth aspect, the present disclosure includes a receiver, comprising: one or more antennas configured to detect one or more radiated signals received from one or more hollow waveguides and generate one or more antenna output signals based on the one or more radiated signals, the one or more radiated signals being radiated electromagnetic waves being configured for coherent detection and having client data encoded therein and one or more frequencies in a range between 300 Gigahertz (GHz) and 10 Terahertz (THz); receiver circuitry configured to receive the one or more antenna output signals from the one or more antennas and generate one or more baseband signals based on the one or more antenna output signals; and a client-side output configured to receive the one or more baseband signals from the receiver circuitry and transmit the one or more baseband signals; wherein each particular antenna of the one or more antennas is a helical antenna.

In a seventh aspect, the present disclosure includes a receiver, comprising: one or more antennas configured to detect one or more radiated signals received from one or more hollow waveguides and generate one or more antenna output signals based on the one or more radiated signals, the one or more radiated signals being radiated electromagnetic waves being configured for coherent detection and having client data encoded therein and one or more frequencies in a range between 300 Gigahertz (GHz) and 10 Terahertz (THz); receiver circuitry configured to receive the one or more antenna output signals from the one or more antennas and generate one or more baseband signals based on the one or more antenna output signals; and a client-side output configured to receive the one or more baseband signals from the receiver circuitry and transmit the one or more baseband signals; wherein each particular antenna of the one or more antennas is a waveguide probe antenna.

In an eighth aspect, the present disclosure includes a receiver, comprising: one or more antennas configured to detect one or more radiated signals received from one or more hollow waveguides and generate one or more antenna output signals based on the one or more radiated signals, the one or more radiated signals being radiated electromagnetic waves being configured for coherent detection and having client data encoded therein and one or more frequencies in a range between 300 Gigahertz (GHz) and 10 Terahertz (THz); receiver circuitry configured to receive the one or more antenna output signals from the one or more antennas and generate one or more baseband signals based on the one or more antenna output signals; and a client-side output configured to receive the one or more baseband signals from the receiver circuitry and transmit the one or more baseband signals; wherein each particular antenna of the one or more antennas is a tapered antenna.

In a ninth aspect, the present disclosure includes a receiver, comprising: one or more antennas configured to detect one or more radiated signals received from one or more hollow waveguides and generate one or more antenna output signals based on the one or more radiated signals, the one or more radiated signals being radiated electromagnetic waves being configured for coherent detection and having client data encoded therein and one or more frequencies in a range between 300 Gigahertz (GHz) and 10 Terahertz (THz); receiver circuitry configured to receive the one or more antenna output signals from the one or more antennas and generate one or more baseband signals based on the one or more antenna output signals; and a client-side output configured to receive the one or more baseband signals from the receiver circuitry and transmit the one or more baseband signals; wherein each particular antenna of the one or more antennas is a patch antenna.

In a tenth aspect, the present disclosure includes a receiver, comprising: one or more antennas configured to detect one or more radiated signals received from one or more hollow waveguides and generate one or more antenna output signals based on the one or more radiated signals, the one or more radiated signals being radiated electromagnetic waves being configured for coherent detection and having client data encoded therein and one or more frequencies in a range between 300 Gigahertz (GHz) and 10 Terahertz (THz); receiver circuitry configured to receive the one or more antenna output signals from the one or more antennas and generate one or more baseband signals based on the one or more antenna output signals; and a client-side output configured to receive the one or more baseband signals from the receiver circuitry and transmit the one or more baseband signals; wherein each of the one or more antennas is a slot antenna.

The foregoing summary provides an overview of certain selected embodiments or embodiments disclosed herein, and is not intended to describe every aspect, embodiment, embodiment, feature, or advantage of the disclosure exhaustively or comprehensively. Therefore, this Summary should not be construed in such a way to limit the scope of this disclosure or to limit the scope of the claims. The details of one or more embodiments disclosed herein are set forth in the accompanying drawings and descriptions below. Other aspects, features, embodiments, embodiments, and advantages will become readily apparent in view of the description, the drawings, and the claims set forth herein.

### BRIEF DESCRIPTION OF THE DRAWINGS

The accompanying drawings, which are incorporated in and constitute a part of this specification, illustrate one or more embodiments described herein and, together with the description, explain these embodiments. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a diagrammatic view of an electromagnetic (EM) spectrum;

FIG. 2 is a block diagram of an exemplary embodiment of a transport network constructed in accordance with the present disclosure;

FIG. 3A is a cross-sectional view of an exemplary embodiment of a first hollow waveguide shown in FIG. 2, taken along the line 3-3′ and in the direction of the arrows;

FIG. 3B is a cross-sectional view of another exemplary embodiment of the first hollow waveguide shown in FIG. 2, taken along the line 3-3′ and in the direction of the arrows, wherein the first hollow waveguide lacks an optional dielectric layer;

FIG. 3C is a cross-sectional view of another exemplary embodiment of the first hollow waveguide shown in FIG. 2, taken along the line 3-3′ and in the direction of the arrows, wherein the first hollow waveguide lacks an optional support layer;

FIG. 3D is a cross-sectional view of another exemplary embodiment of the first hollow waveguide shown in FIG. 2, taken along the line 3-3′ and in the direction of the arrows, wherein the first hollow waveguide lacks the optional dielectric layer and the optional support layer;

FIG. 3E is a cross-sectional view of another exemplary embodiment of the first hollow waveguide shown in FIG. 2, taken along the line 3-3′ and in the direction of the arrows, wherein the first hollow waveguide is a photonic-bandgap fiber;

FIG. 3F is a cross-sectional view of another exemplary embodiment of the first hollow waveguide shown in FIG. 2, taken along the line 3-3′ and in the direction of the arrows, wherein the first hollow waveguide has a hollow waveguide core with an elliptical cross-section;

FIG. 3G is a cross-sectional view of another exemplary embodiment of the first hollow waveguide shown in FIG. 2, taken along the line 3-3′ and in the direction of the arrows, wherein the hollow waveguide core of the first hollow waveguide has a rectangular cross-section;

FIG. 3H is a cross-sectional view of another exemplary embodiment of the first hollow waveguide shown in FIG. 2, taken along the line 3-3′ and in the direction of the arrows, wherein the hollow waveguide core of the first hollow waveguide has a square cross-section;

FIG. 3I is a cross-sectional view of another exemplary embodiment of the first hollow waveguide shown in FIG. 2, taken along the line 3-3′ and in the direction of the arrows, wherein the hollow waveguide core of the first hollow waveguide has a cross-shaped cross-section;

FIG. 3J is a cross-sectional view of another exemplary embodiment of the first hollow waveguide shown in FIG. 2, taken along the line 3-3′ and in the direction of the arrows, wherein the first hollow waveguide is a solid rod fiber;

FIG. 3K is a cross-sectional view of another exemplary embodiment of the first hollow waveguide shown in FIG. 2, taken along the line 3-3′ and in the direction of the arrows, wherein the first hollow waveguide is a microstructured optical fiber;

FIG. 3L is a cross-sectional view of another exemplary embodiment of the first hollow waveguide shown in FIG. 2, taken along the line 3-3′ and in the direction of the arrows, wherein the first hollow waveguide is a porous fiber;

FIG. 3M is a cross-sectional view of another exemplary embodiment of the first hollow waveguide shown in FIG. 2, taken along the line 3-3′ and in the direction of the arrows, wherein the first hollow waveguide is a suspended porous-core fiber;

FIG. 3N is a cross-sectional view of another exemplary embodiment of the first hollow waveguide shown in FIG. 2, taken along the line 3-3′ and in the direction of the arrows, wherein the first hollow waveguide is a suspended slotted core fiber;

FIG. 3O is a cross-sectional view of another exemplary embodiment of the first hollow waveguide shown in FIG. 2, taken along the line 3-3′ and in the direction of the arrows, wherein the first hollow waveguide is a hollow-core bandgap fiber;

FIG. 3P is a cross-sectional view of another exemplary embodiment of the first hollow waveguide shown in FIG. 2, taken along the line 3-3′ and in the direction of the arrows, wherein the first hollow waveguide is a hollow-core tube fiber;

FIG. 3Q is a cross-sectional view of another exemplary embodiment of the first hollow waveguide shown in FIG. 2, taken along the line 3-3′ and in the direction of the arrows, wherein the first hollow waveguide is a hollow-core fiber with negative curvature;

FIG. 3R is a cross-sectional view of another exemplary embodiment of the first hollow waveguide shown in FIG. 2, taken along the line 3-3′ and in the direction of the arrows, wherein the first hollow waveguide is a hollow-core fiber based on anti-resonances and inhibited coupling;

FIG. 3S is a cross-sectional view of another exemplary embodiment of the first hollow waveguide shown in FIG. 2, taken along the line 3-3′ and in the direction of the arrows, wherein the first hollow waveguide is a hollow-core nested anti-resonant nodeless fiber;

FIG. 3T is a cross-sectional view of another exemplary embodiment of the first hollow waveguide shown in FIG. 2, taken along the line 3-3′ and in the direction of the arrows, wherein the first hollow waveguide is a 3D-printed hollow-core fiber based on anti-resonances and inhibited coupling;

FIG. 3U is a cross-sectional view of another exemplary embodiment of the first hollow waveguide shown in FIG. 2, taken along the line 3-3′ and in the direction of the arrows, wherein the first hollow waveguide is a Bragg fiber;

FIG. 4A is a block diagram of an exemplary embodiment of a first transmitter shown in FIG. 2;

FIG. 4B is a block diagram of another exemplary embodiment of the first transmitter shown in FIG. 2, wherein the first transmitter comprises a serializer;

FIG. 4C is a block diagram of another exemplary embodiment of the first transmitter shown in FIG. 2, wherein the first transmitter comprises a deserializer;

FIG. 4D is a block diagram of an exemplary embodiment of transmitter circuitry shown in FIG. 4A;

FIG. 4E is a block diagram of another exemplary embodiment of the transmitter circuitry shown in FIG. 4A, wherein the transmitter circuitry comprises a combiner;

FIG. 4F is a block diagram of another exemplary embodiment of the first transmitter shown in FIG. 2;

FIG. 4G is a block diagram of another exemplary embodiment of the first transmitter shown in FIG. 2;

FIG. 5A is a block diagram of an exemplary embodiment of a first receiver shown in FIG. 2;

FIG. 5B is a block diagram of another exemplary embodiment of the first receiver shown in FIG. 2, wherein the first receiver comprises a deserializer;

FIG. 5C is a block diagram of another exemplary embodiment of the first receiver shown in FIG. 2, wherein the first receiver comprises a serializer;

FIG. 5D is a block diagram of an exemplary embodiment of receiver circuitry shown in FIG. 5A;

FIG. 5E is a block diagram of another exemplary embodiment of the receiver circuitry shown in FIG. 5A, wherein the receiver circuitry comprises a splitter;

FIG. 5F is a block diagram of another exemplary embodiment of the first receiver shown in FIG. 2;

FIG. 5G is a block diagram of another exemplary embodiment of the first receiver shown in FIG. 2;

FIG. 6A is a block diagram of an exemplary embodiment of a transceiver shown in FIG. 2;

FIG. 6B is a block diagram of another exemplary embodiment of the transceiver shown in FIG. 2;

FIG. 7 is a schematic diagram of a folded modulator constructed in accordance with the present disclosure;

FIG. 8 is a schematic diagram of a rectifying detector constructed in accordance with the present disclosure;

FIG. 9A is a side view of an exemplary embodiment of an antenna constructed in accordance with the present disclosure for generating circularly polarized signals;

FIG. 9B is a side view of another exemplary embodiment of the antenna shown in FIG. 9A;

FIG. 10 is a perspective view of another exemplary embodiment of the antenna shown in FIG. 9A, wherein the antenna is a bifilar helix antenna;

FIG. 11 is a perspective view of another exemplary embodiment of the bifilar helix antenna shown in FIG. 10, wherein the bifilar helix antenna is enclosed within a conductive cone;

FIG. 12 is a partial cross-sectional view of the bifilar helix antenna shown in FIG. 11, taken from the line 12-12′ and in the direction of the arrows;

FIG. 13 is a diagrammatic view of an electric field produced by the bifilar helix antenna enclosed within the conductive cone shown in FIG. 12;

FIG. 14 is a diagrammatic view of a radiation pattern of the bifilar helix antenna enclosed within the conductive cone shown in FIG. 12;

FIG. 15 is a side view of an exemplary embodiment of a non-uniform bifilar helix antenna constructed in accordance with the present disclosure;

FIG. 16 is a side view of another exemplary embodiment of the non-uniform bifilar helix antenna;

FIG. 17 is a graphical view of a polarization discrimination of the non-uniform bifilar helix antenna shown in FIG. 15;

FIG. 18 is a graphical view of a polarization discrimination of the non-uniform bifilar helix antenna shown in FIG. 16;

FIG. 19 is a side view of another exemplary embodiment of the non-uniform bifilar helix antenna;

FIG. 20 is a side view of another exemplary embodiment of the non-uniform bifilar helix antenna;

FIG. 21A is a diagrammatic front view of an exemplary embodiment of a differential waveguide probe antenna constructed in accordance with the present disclosure;

FIG. 21B is a diagrammatic side view of the differential waveguide probe antenna shown in FIG. 21A;

FIG. 22A is a partial cross-sectional view of the differential waveguide probe antenna shown in FIG. 21A, taken from the line 22-22′ and in the direction of the arrows;

FIG. 22B is another partial cross-sectional view of the differential waveguide probe antenna shown in FIG. 22A, taken from the line 23-23′ and in the direction of the arrows;

FIG. 22C is another partial cross-sectional view of the differential waveguide probe antenna shown in FIG. 22B, taken from the line 24-24′ and in the direction of the arrows;

FIG. 22D is a graphical view of a polarization discrimination of the differential waveguide probe antenna shown in FIG. 21A;

FIG. 23 a diagrammatic view of an exemplary embodiment of a differential tapered antenna constructed in accordance with the present disclosure;

FIG. 24A is a partial cross-sectional view of the differential tapered antenna shown in FIG. 23, taken from the line 27-27′ and in the direction of the arrows;

FIG. 24B is another partial cross-sectional view of the differential tapered antenna shown in FIG. 24A, taken from the line 28-28′ and in the direction of the arrows;

FIG. 24C is a graphical view of a polarization discrimination of the differential tapered antenna shown in FIG. 23;

FIG. 25A is a diagrammatic front view of an exemplary embodiment of a microstrip patch antenna array constructed in accordance with the present disclosure;

FIG. 25B is a diagrammatic side view of the microstrip patch antenna array shown in FIG. 25A;

FIG. 26A is a diagrammatic front view of an exemplary embodiment of a single-ended waveguide probe antenna constructed in accordance with the present disclosure;

FIG. 26B is a diagrammatic side view of the single-ended waveguide probe antenna shown in FIG. 26A;

FIG. 27A is a cross-sectional view of the single-ended waveguide probe antenna shown in FIG. 26A, taken along the line 55-55′ and in the direction of the arrows;

FIG. 27B is another cross-sectional view of the single-ended waveguide probe antenna shown in FIG. 26A, taken along the line 56-56′ and in the direction of the arrows;

FIG. 27C is a partial cross-sectional view of the single-ended waveguide probe antenna shown in FIG. 27B, taken along the line 57-57′ and in the direction of the arrows;

FIG. 28A is a diagrammatic front view of an exemplary embodiment of a slot antenna constructed in accordance with the present disclosure;

FIG. 28B is a diagrammatic side view of the slot antenna shown in FIG. 28A;

FIG. 29A is a cross-sectional view of the slot antenna shown in FIG. 28A, taken along the line 59-59′ and in the direction of the arrows;

FIG. 29B is a partial cross-sectional view of the slot antenna shown in FIG. 29A, taken along the line 60-60′ and in the direction of the arrows;

FIG. 29C is another partial cross-sectional view of the slot antenna shown in FIG. 29A, taken along the line 61-61′ and in the direction of the arrows;

FIG. 30A is a cross-sectional view of another embodiment of the slot antenna shown in FIG. 28A, taken along the line 59-59′ and in the direction of the arrows, wherein the slot antenna is a double slot antenna;

FIG. 30B is a partial cross-sectional view of the slot antenna shown in FIG. 30A, taken along the line 63-63′ and in the direction of the arrows; and

FIG. 30C is another partial cross-sectional view of the slot antenna shown in FIG. 30A, taken along the line 64-64′ and in the direction of the arrows.

### DETAILED DESCRIPTION

The following detailed description refers to the accompanying drawings. The same reference numbers in different drawings may identify the same or similar elements.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular also includes the plural unless it is obvious that it is meant otherwise.

Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

The use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, all numerical values or ranges include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-50 therefore includes 1, 2, 3, 4, 5, 6, 7, 8, 9, 10, 11, 12, 13, 14, 15, 16, 17, 18, 19, 20, etc., up to and including 50, as well as 1.1, 1.2, 1.3, 1.4, 1.5, etc., 2.1, 2.2, 2.3, 2.4, 2.5, etc., and so forth. Reference to a series of ranges includes ranges which combine the values of the boundaries of different ranges within the series. Thus, to illustrate reference to a series of ranges, for example, of 1-10, 10-20, 20-30, 30-40, 40-50, 50-60, 60-75, 75-100, 100-150, 150-200, 200-250, 250-300, 300-400, 400-500, 500-750, 750-1,000, includes ranges of 1-20, 10-50, 50-100, 100-500, and 500-1,000, for example.

As used herein, “circuitry” may refer to analog and/or digital components, or one or more suitably programmed processors (e.g., a microprocessor) and associated hardware and software, or hardwired logic. Also, “circuitry” may perform one or more functions. The term “circuitry” may include hardware, such as a processor (e.g., microprocessor), a combination of hardware and software, and/or the like. Software may include one or more processor-executable instructions that when executed by one or more processors cause the one or more processors to perform a specified function. It should be understood that the algorithms described herein may be stored on one or more non-transitory memories. Exemplary non-transitory memories may include a random-access memory (RAM), a read-only memory (ROM), a flash memory, combinations thereof, and/or the like. Such non-transitory memories may be electrically based, optically based, combinations thereof, and/or the like.

As used herein, a “mode” refers to a unique distribution of electric and magnetic fields which repeat along the length of a hollow waveguide by which electromagnetic energy may be transported through the hollow waveguide. “Single-mode” refers to a hollow waveguide designed to carry only one mode of electromagnetic wave. This is achieved by having a narrow core diameter, which allows only one mode of light to propagate at a time. On the other hand, “multi-mode” refers to a hollow waveguide designed to carry multiple modes of electromagnetic waves simultaneously. This is possible due to its larger core diameter, which enables multiple modes to be propagated.

As used herein, “Amplitude Modulation” (AM) refers to a form of signal modulation in which data is encoded in an amplitude of a carrier signal.

As used herein, “Amplitude-Shift Keying” (ASK) refers to a form of AM in which digital data is encoded in an amplitude of a carrier signal, and each symbol (i.e., representing one or more data bits) is sent by transmitting a fixed-amplitude carrier wave at a fixed frequency for a specific time period.

As used herein, “diameter” refers to a straight line passing from side to side through a center of a body or figure, especially, but not limited to an ellipse, a circle, or a sphere.

As used herein, “Phase-Shift Keying” (PSK) is a form of signal modulation in which signal data is encoded in a phase of a carrier signal having a constant frequency. “Quadrature PSK” (PSK) Is a form of PSK in which two data bits (i.e., 00, 01, 10, or 11) are modulated at once, selecting one of four possible carrier phase shifts (i.e., 0°, 90°, 180°, or) 270°.

As used herein, “Pulse-Amplitude Modulation” (PAM) refers to a form of AM in which a data signal is encoded in an amplitude of a series of carrier signal pulses. “PAM4” refers to a form of PAM in which a data signal is encoded in an amplitude of a series of carrier signal pulses, in which the amplitude of the carrier signal pulses may be one of four discrete values (i.e., 0, 1, 2, or 3) and each carrier signal pulse represents two data bits (i.e., 00, 01, 10, or 11).

As used herein, “Non-Return-to-Zero” (NRZ) refers to a form of signal modulation in which a binary data signal is encoded in a carrier signal such that ones are represented by a first significant condition (e.g., a positive voltage) and zeroes are represented by a second significant condition (e.g., a negative voltage). “Non-return-to-Zero, Inverted” (NRZI) refers to a form of signal modulation in which the data bits are represented by the presence or absence of a transition at a clock boundary.

As used herein, “Quadrature Amplitude Modulation” (QAM) refers to a form of AM in which two analog message signals or two digital bit streams are encoded in amplitudes of two carrier waves, using either ASK or AM, and the two carrier signals are out of phase with each other by 90°. “QAM16” refers to a form of QAM in which the carrier signals may exist in one of sixteen discrete states (i.e., symbols) having one of sixteen different amplitude and phase levels representing four data bits (i.e., from 0000 to 1111).

As used herein, “Trellis Coded Modulation” (TCM) refers to a form of signal modulation in which a binary data signal is encoded in a phase of a constant amplitude carrier signal. The transmitted signal is created by convolutionally encoding the binary data signal and mapping the result to a signal constellation.

As used herein, “Rayleigh range” refers to the distance along the propagation direction of a beam from the waist to the place where the area of the cross section is doubled.

As used herein, “hollow waveguide” refers to a structure that guides waves by restricting transmission of energy in a particular direction. In the context of the present disclosure, “hollow waveguide” may refer to an optical fiber having a waveguide core operable to propagate RF signals in the THz frequency band or a routed waveguide operable to propagate RF signals in the THz frequency band.

As used herein, “diameter” refers to a straight line passing from side to side through the center of a body or figure. In some embodiments, the body or figure has a circular or elliptical shape.

As used herein, “data” refers to quantities, characters, or symbols on which operations are performed by a computer. Data can be recorded on a non-transitory computer readable medium, such as random-access memory and/or read only memory. The random-access memory and/or read only memory may be implemented on semiconductor, magnetic, optical, or mechanical recording media. An example of data is client data, e.g., data provided by a client in connection with a telecommunication service and/or a storage service.

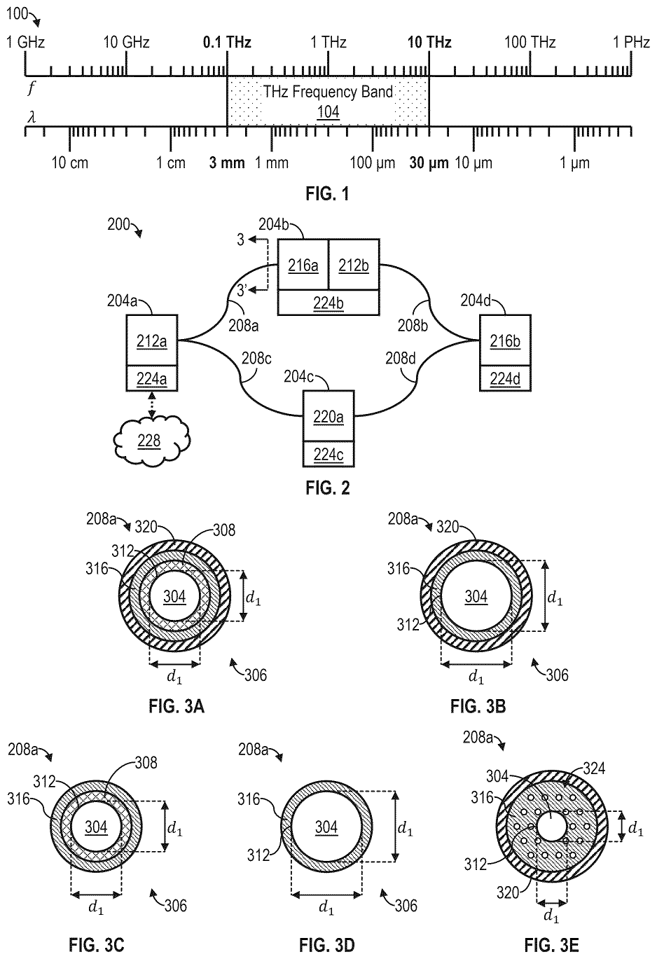

Referring now to the drawings, and in particular to FIG. 1, shown therein is a diagrammatic view of an electromagnetic (EM) spectrum 100 in accordance with the present disclosure. The present disclosure is generally related to network elements that communicate using radiated signals comprising radiated electromagnetic waves coupled into hollow waveguides. The radiated signals described herein generally have a transmission frequency in what is referred to as a Terahertz (THz) frequency band 104 (i.e., frequencies between 0.1 THz and 10 THz corresponding to wavelengths between 3 millimeters (mm) and 30 micrometers (μm)). However, in some embodiments described herein, the transmission frequency of the radiated signals is in a range between 300 Gigahertz (GHz) and 10 THz. The radiated signals described herein are generally configured for coherent detection and generally have a bandwidth in a range between 10% and 40% of the transmission frequency.

Referring now to FIG. 2, shown therein is a block diagram of an exemplary embodiment of a transport network 200 (hereinafter, the “transport network 200”) constructed in accordance with the present disclosure. The transport network 200 is depicted as comprising a plurality of network elements 204a-n (hereinafter, the “network elements 204”) (e.g., a first network element 204a, a second network element 204b, a third network element 204c, and a fourth network element 204d shown in FIG. 2). While only four of the network elements 204 are shown in FIG. 2 for exemplary purposes, it should be understood that the transport network 200 may comprise a number of the network elements 204 that may be greater or fewer than four.

The transport network 200 may further comprise one or more hollow waveguides 208a-n (hereinafter, the “hollow waveguides 208”) (e.g., a first hollow waveguide 208a, a second hollow waveguide 208b, a third hollow waveguide 208c, and a fourth hollow waveguide 208d shown in FIG. 2). While only four of the hollow waveguides 208 are shown in FIG. 2 for exemplary purposes, it should be understood that the transport network 200 may comprise a number of the hollow waveguides 208 that may be greater or fewer than four.

Radiated signals transmitted within the transport network 200 from the first network element 204a to the fourth network element 204d or vice versa may travel along (1) a first path formed by the first hollow waveguide 208a, the second network element 204b, and the second hollow waveguide 208b or (2) a second path formed by the third hollow waveguide 208c, the third network element 204c, and the fourth hollow waveguide 208d.

In some embodiments, each of the hollow waveguides 208 is configured to support propagation of radiated signals in only a single direction. However, in other embodiments, one or more of the hollow waveguides 208 may be configured to support propagation of radiated signals in a plurality of directions (i.e., two opposing directions). In embodiments where one or more of the hollow waveguides 208 are configured to support propagation of radiated signals in a plurality of directions, a first radiated signal being propagated through the hollow waveguide 208 in a first direction may be differentiated from a second radiated signal being propagated through the hollow waveguide 208 in a second direction opposite the first direction by being provided with a different polarization, frequency, etc. In some such embodiments, one or more circulators may be included to achieve such differentiation.

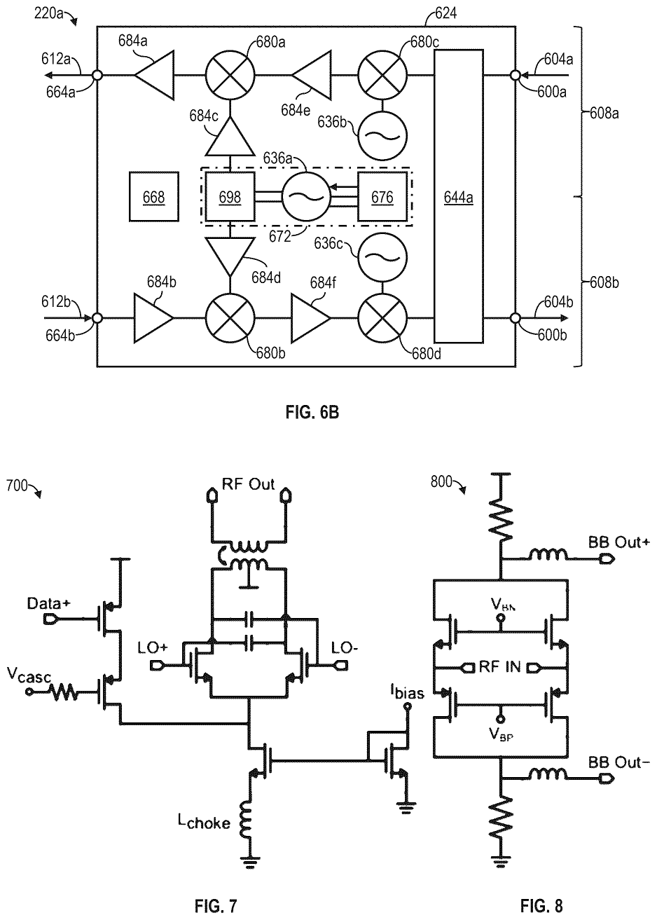

Each of the network elements 204 may comprise one or more of a transmitter 212 (e.g., a first transmitter 212a and a second transmitter 212b shown in FIG. 2) operable to transmit radiated signals comprising radiated electromagnetic waves having client data encoded therein via the hollow waveguides 208, a receiver 216 (e.g., a first receiver 216a and a second receiver 216b shown in FIG. 2) operable to receive radiated signals comprising radiated electromagnetic waves having client data encoded therein via the hollow waveguides 208, and/or a transceiver 220 (e.g., a first transceiver 220a shown in FIG. 2 and a second transceiver 220b shown in FIG. 6B) operable to transmit first radiated signals comprising first radiated electromagnetic waves having first client data encoded therein via particular ones of the hollow waveguides 208 and/or receive second radiated signals comprising second radiated electromagnetic waves having second client data encoded therein via other ones of the hollow waveguides 208.

Each of the network elements 204 may further comprise a control module 224 (e.g., a first control module 224a, a second control module 224b, a third control module 224c, and a fourth control module 224d shown in FIG. 2) (collectively, the “control modules 224”) operable to regulate one or more operating parameters of the network element 204 to which the control module 224 is coupled.

In some embodiments, one or more of the network elements 204 may communicate with each other via a communication network 228. The communication network 228 may permit bidirectional communication of information and/or data between one or more of the network elements 204 of the transport network 200. The communication network 228 may interface with one or more of the network elements 204 in a variety of ways. For example, in some embodiments, the communication network 228 may interface by optical and/or electronic interfaces, and/or may use a plurality of network topographies and/or protocols including, but not limited to, Ethernet, TCP/IP, circuit switched path, combinations thereof, and/or the like. The communication network 228 may utilize a variety of network protocols to permit bidirectional interface and/or communication of data and/or information between one or more of the network elements 204.

The communication network 228 may be almost any type of network. For example, in some embodiments, the communication network 228 may be a version of an Internet network (e.g., exist in a TCP/IP-based network). In one embodiment, the communication network 228 is the Internet. It should be noted, however, that the communication network 228 may be almost any type of network and may be implemented as the World Wide Web (i.e., the Internet), a local area network (LAN), a wide area network (WAN), a metropolitan network, a wireless network, a cellular network, a Bluetooth network, a Global System for Mobile Communications (GSM) network, a code division multiple access (CDMA) network, a 3G network, a 4G network, an LTE network, a 5G network, a satellite network, a radio network, an optical network, a cable network, a public switched telephone network, an Ethernet network, combinations thereof, and/or the like.

If the communication network 228 is the Internet, a primary user interface of the transport network 200 may be delivered through a series of web pages or private internal web pages of a company or corporation, which may be written in hypertext markup language, JavaScript, or the like, and accessible by the user. It should be noted that the primary user interface of the transport network 200 may be another type of interface including, but not limited to, a Windows-based application, a tablet-based application, a mobile web interface, a VR-based application, an application running on a mobile device, and/or the like. In one embodiment, the communication network 228 may be connected to one or more of the network elements 204.

The number of devices and/or networks illustrated in FIG. 2 is provided for exemplary purposes. In practice, there may be additional devices and/or networks, fewer devices and/or networks, different devices and/or networks, or differently arranged devices and/or networks than are shown in FIG. 2. Furthermore, two or more of the devices illustrated in FIG. 2 may be implemented within a single device, or a single device illustrated in FIG. 2 may be implemented as multiple, distributed devices. Additionally, or alternatively, one or more of the devices of the transport network 200 may perform one or more functions described as being performed by another one or more of the devices of the transport network 200.

The network elements 204 may take many different forms. For example, the network elements 204 may be integrated circuits (ICs). In this example, the network elements 204 (e.g., ICs) may communicate via signals comprising radiated electromagnetic waves having client data encoded therein via the hollow waveguides 208 without requiring electrical data busses. In other embodiments, the network elements 204 may be incorporated into components in a data center, such as servers, routers, switches, firewalls, storage systems, application delivery controllers, and/or the like to establish communication between such components in the data center via signals comprising radiated electromagnetic waves having client data encoded therein propagated through the hollow waveguides 208. The hollow waveguides 208 may thus extend from one integrated circuit to another integrated circuit, or from one component to another component, and such may be implemented in a variety of ways, such as IC-to-IC communications, printed circuit board (PCB)-to-PCB communications, component-to-component communications, and/or combinations thereof. In the example of PCB-to-PCB communications, the network elements 204 may each include a PCB.

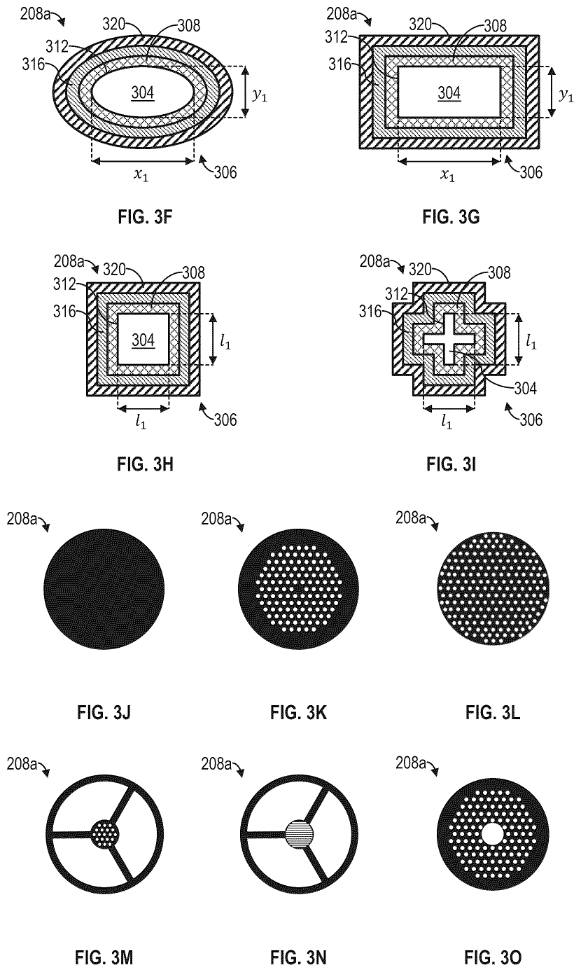

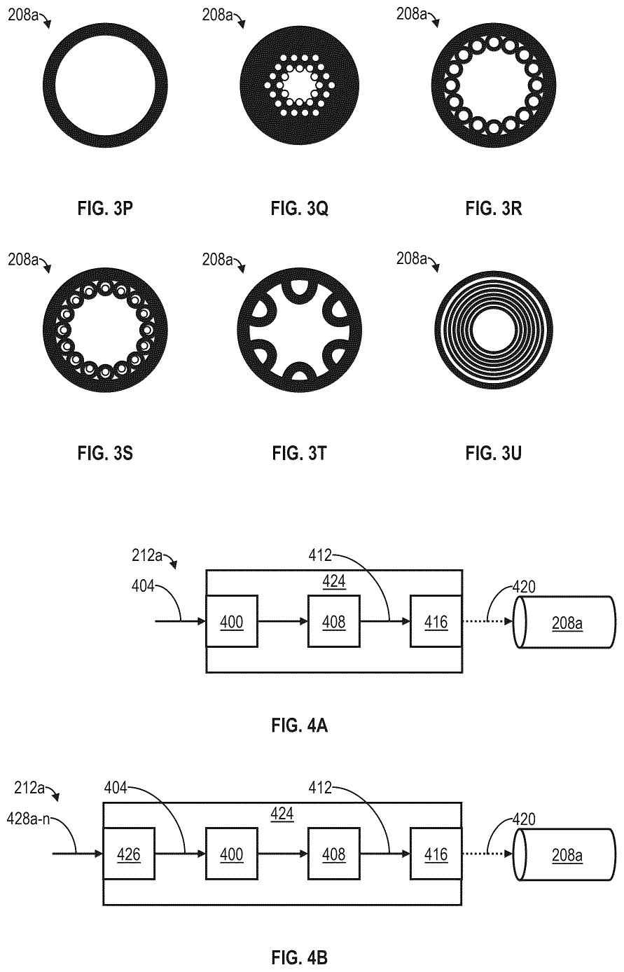

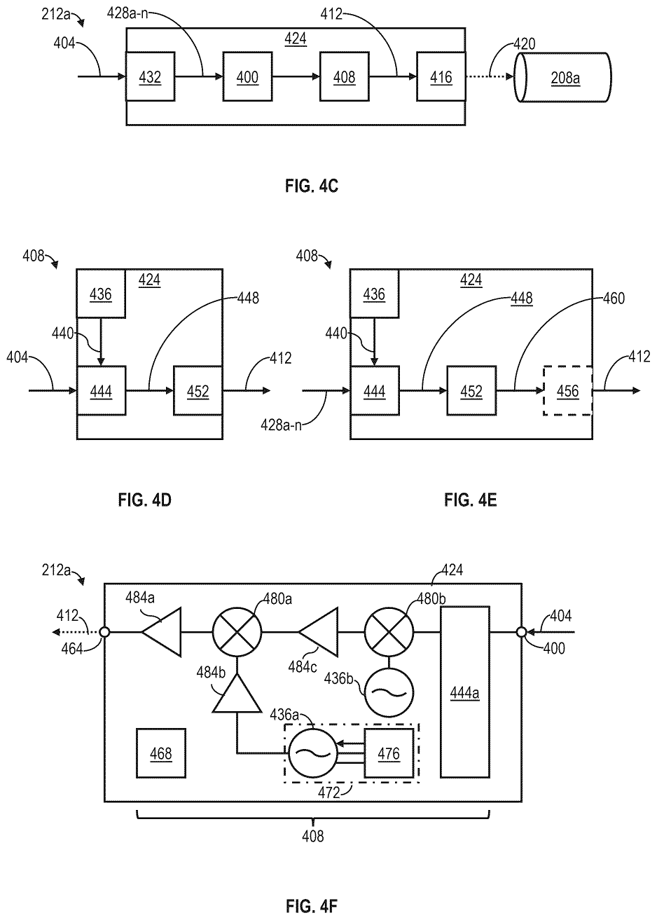

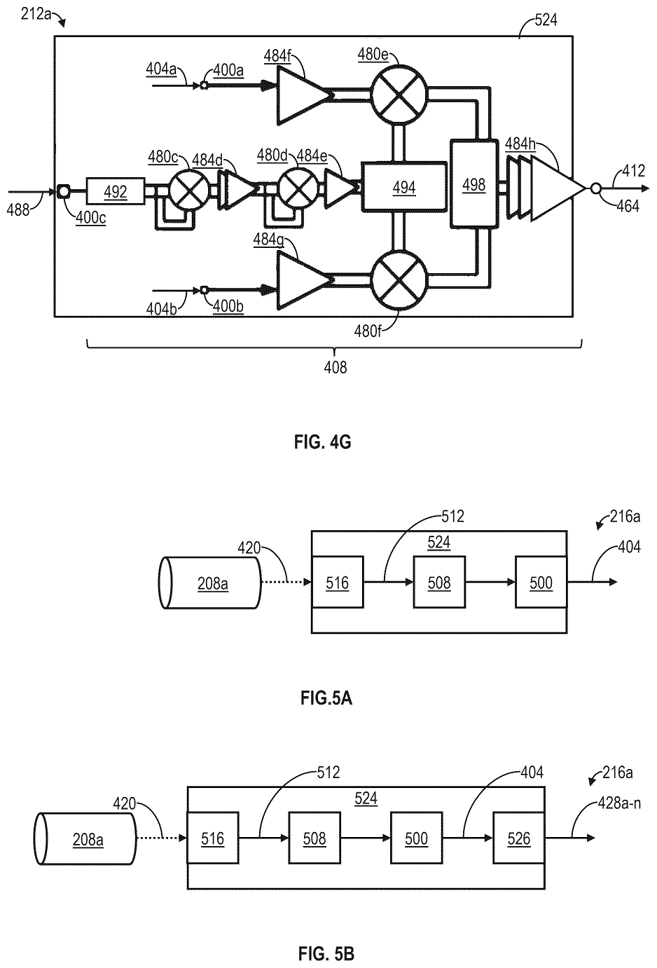

Referring now to FIGS. 3A-3H and 4A-4L, shown therein are cross-sectional views of various exemplary embodiments of the first hollow waveguide 208a shown in FIG. 2, taken along the line 3-3′ and in the direction of the arrows. However, it should be understood that the description referring to FIGS. 3A-3H and 4A-4L may be applicable to any of the hollow waveguides 208 described herein. In the embodiments shown in FIGS. 3A-3H and 4A-4L, the first hollow waveguide 208a is a hollow fiber. However, it should be understood that in other embodiments, the first hollow waveguide 208a may be another form of hollow waveguide, such as a substrate-integrated waveguide, for example.

The first hollow waveguide 208a (and, therefore, each of the hollow waveguides 208) generally comprises a hollow waveguide core 304 and a tubular sidewall 306 having an inner surface 312 in some embodiments defining the hollow waveguide core 304 or in other embodiments simply surrounding the hollow waveguide core 304.

Generally, the hollow waveguide core 304 may be composed of any material capable of propagating radiated electromagnetic waves within the THz frequency band 104 or, in some embodiments, in the range between 300 GHz and 10 THz. More particularly, the hollow waveguide core 304 may be composed of any materials having a low absorption loss (i.e., an absorption loss in a range between 1 dB/km and 10,000 dB/km) within the THz frequency band 104, or in some embodiments, in the range between 300 GHz and 10 THz.

In some embodiments, the hollow waveguide core 304 may be composed of a polymer (e.g., cyclo olefin polymer (COP), cyclic olefin co-polymer (COC), polytetrafluoroethylene (PTFE), high-density polyethylene (HDPE), polymethylpentene (PMP), polypropylene (PP), polystyrene, polycarbonate, poly(methyl methacrylate) (PMMA), Picarin, or ultraviolet (UV) resin) or glass (e.g., silica glass, crown glass, or borosilicate glass).

In other embodiments, the hollow waveguide core 304 may be composed of a gas, a vacuum, or a porous material (i.e., a material having a porosity in a range between 25% and 99%). In such embodiments, the hollow waveguide core 304 may have a refractive index in a range between 1.0 and 1.4, for example. As discussed in more detail below, the hollow waveguide core 304 may have a refractive index n₁.

In some embodiments, the hollow waveguide core 304 may have a cross-section configured to support propagation of radiated signals having only a single polarization at a given time. However, in other embodiments, the hollow waveguide core 304 may have a cross-section configured to support propagation of radiated signals having a plurality of polarizations at a given time. In either case, the hollow waveguide core 304 may have a cross-section configured to support propagation of radiated signals having one or more linear polarizations or one or more circular polarizations.

In some embodiments, the hollow waveguide core 304 may have a cross-section configured to support propagation of radiated signals having only a single mode at a given time. However, in other embodiments, the hollow waveguide core 304 may have a cross-section configured to support propagation of radiated signals having a plurality of modes at a given time.

The tubular sidewall 306 of the first hollow waveguide 208a (and, therefore, each of the hollow waveguides 208) may comprise a conductive layer 316 (shown in FIGS. 3A-3I) surrounding the hollow waveguide core 304, a dielectric layer 308 (shown in FIGS. 3A, 3C, and 3F-3I) optionally disposed between the hollow waveguide core 304 and the conductive layer 316, and a support layer 320 (shown in FIGS. 3A, 3B, and 3E-3I) optionally surrounding the conductive layer 316.

In some embodiments, the tubular sidewall 306 of the first hollow waveguide 208a (and, therefore, each of the hollow waveguides 208) may comprise a plurality of the conductive layer 316 interleaved with a plurality of the dielectric layer 308.

In some embodiments, the tubular sidewall 306 of the first hollow waveguide 208a (and, therefore, each of the hollow waveguides 208) may further comprise one or more strength members (not shown) (hereinafter, the “strength members”) surrounding the conductive layer 316 configured to enhance resilience of the first hollow waveguide 208a. In such embodiments, the support layer 320 may surround the strength members.

Generally, the conductive layer 316 may be composed of any material having a refractive index n₃ greater than the refractive index of the hollow waveguide core 304 (i.e., n₁). More particularly, the conductive layer 316 may be composed of a non-oxidizing metallic material (e.g., silver, gold, or indium tin oxide (ITO)). Providing the conductive layer 316 with a refractive index greater than the refractive index of the hollow waveguide core 304 may cause an effective index Δn of the first hollow waveguide 208a to increase, thereby causing more radiated signals to be confined and propagated within the hollow waveguide core 304.

Generally, in embodiments in which the dielectric layer 308 is disposed between the conductive layer 316 and the hollow waveguide core 304, the dielectric layer 308 may be composed of any material having a refractive index n₂ greater than the refractive index of the hollow waveguide core 304 (i.e., n₁). More particularly, the dielectric layer 308 may be composed of a polymer (e.g., cyclo olefin polymer (COP), cyclic olefin co-polymer (COC), polytetrafluoroethylene (PTFE), high-density polyethylene (HDPE), polymethylpentene (PMP), polypropylene (PP), polystyrene, polycarbonate, poly(methyl methacrylate) (PMMA), Picarin, or ultraviolet (UV) resin) or glass (e.g., silica glass, crown glass, or borosilicate glass), but particularly a material having a refractive index n₂ greater than the refractive index of the hollow waveguide core 304 (i.e., n₁) in that embodiment. Providing the dielectric layer 308 with a refractive index greater than the refractive index of the hollow waveguide core 304 may cause an effective index Δn of the first hollow waveguide 208a to increase, thereby causing more radiated signals to be confined and propagated within the hollow waveguide core 304.

The support layer 320 may be configured to shield the inner layers of the first hollow waveguide 208a (and, therefore, any of the hollow waveguides 208) from external environmental factors, provide flexibility to the first hollow waveguide 208a, and/or enhance a tensile strength of the first hollow waveguide 208a. In some embodiments, the support layer 320 may be composed of polymer materials, such as acrylate polymer or polyimide, for example.

In some embodiments, the cross-section of the hollow waveguide core 304 may have a circular shape (i.e., having a diameter d₁ that is equal along both the x-axis and the y-axis) (shown in FIGS. 3A-3D). In some such embodiments, the diameter d₁ of the hollow waveguide core 304 may be between 30 μm and 6 mm. In some such embodiments, the diameter d₁ of the hollow waveguide core 304 may be between 30 μm and 3 mm. In at least one such embodiment, the diameter d₁ of the hollow waveguide core 304 may be 1 mm.

In some embodiments, as shown in FIG. 3E, the first hollow waveguide 208a may be a photonic-bandgap fiber comprising a plurality of air channels 324 (hereinafter the “air channels 324”) periodically spaced throughout the conductive layer 316.

In other embodiments, the cross-section of the hollow waveguide core 304 may have an elliptical shape (i.e., having a first diameter x₁ along the x-axis and a second diameter y₁ along the y-axis, wherein the first diameter is not equal to the second diameter) (shown in FIG. 3F), a rectangular shape (shown in FIG. 3G) (i.e., having a first length x₁ along the x-axis and a second length y₁ along the y-axis, wherein the first length is not equal to the second length), a square shape (i.e., having a length l₁ that is equal along both the x-axis and the y-axis) (shown in FIG. 3H), or a cross shape (i.e., having a length l₁ that is equal along both the x-axis and the y-axis) (shown in FIG. 3I), for example.

In other embodiments, the first hollow waveguide 208a (and, therefore, any of the hollow waveguides 208) may be implemented as a solid rod fiber (shown in FIG. 3J), a microstructured optical fiber (shown in FIG. 3K), a porous fiber (shown in FIG. 3L), a suspended porous-core fiber (shown in FIG. 3M), a suspended slotted core fiber (shown in FIG. 3N), a hollow-core bandgap fiber (shown in FIG. 3O), a hollow-core tube fiber (shown in FIG. 3P), a hollow-core fiber with negative curvature (shown in FIG. 3Q), a hollow-core fiber based on anti-resonances and inhibited coupling (shown in FIG. 3R), a hollow-core nested anti-resonant nodeless fiber (shown in FIG. 3S), a 3D-printed hollow-core fiber based on anti-resonances and inhibited coupling (shown in FIG. 3T), or a Bragg fiber (shown in FIG. 3U), for example.

Referring now to FIG. 4A, shown therein is a block diagram of an exemplary embodiment of the first transmitter 212a shown in FIG. 2. However, it should be understood that the description of any particular one of the transmitter 212 may be applicable to any of the transmitters 212 described herein. The first transmitter 212a (and, therefore, each of the transmitters 212) generally comprises a client-side input 400 configured to receive one or more baseband signals 404 (hereinafter, the “baseband signals 404”) having client data encoded therein from one or more external components (e.g., a control module 224), transmitter circuitry 408 configured to receive the baseband signals 404 from the client-side input 400 and generate one or more antenna feed signals 412 (hereinafter, the “antenna feed signals 412”) based on the baseband signals 404, and one or more first antennas 416 configured to receive the antenna feed signals 412 from the transmitter circuitry 408, generate one or more radiated signals 420 (hereinafter, the “radiated signals 420”) based on the antenna feed signals 412, and couple the radiated signals 420 into the first hollow waveguide 208a.

In some embodiments, the client-side input 400 is a pair of inputs configured to receive a differential signal. In some such embodiments, the client-side input 400 may be a low voltage differential signaling (LVDS) link configured to receive LVDS signals, and the baseband signals 404 may be LVDS signals indicative of client data.

In some embodiments, the antenna feed signals 412 are provided to the first antennas 416 on one or more transmission lines (not shown) (hereinafter, the “transmission lines”), wherein each of the transmission lines has two or more conductors (not shown) (hereinafter, the “conductors”). In some embodiments, the transmission lines have a first transmission loss and the first hollow waveguide 208a has a second transmission loss that is less than the first transmission loss. In some embodiments, the second transmission loss is in a range between 0.001 and 20.00 decibels (dB) per meter (m) per Terabit (Tb) per second(s).

In some embodiments, as shown in FIG. 4A, each of the client-side input 400, the transmitter circuitry 408, and the first antennas 416 may be disposed on a substrate 424. However, in other embodiments, one or more of the client-side input 400, the transmitter circuitry 408, and the first antennas 416 may be disposed on a first substrate (not shown), and one or more of the client-side input 400, the transmitter circuitry 408, and the first antennas 416 may not be disposed on the first substrate. For example, the one or more of the client-side input 400, the transmitter circuitry 408, and the first antennas 416 may be disposed on a second substrate (not shown). In such embodiments, the first substrate and the second substrate may be in a stacked arrangement.

In some embodiments, the substrate 424 may have a plurality of layers (not shown). In such embodiments, one or more of the client-side input 400, the transmitter circuitry 408, and the first antennas 416 may be disposed on a first layer (not shown), and one or more of the client-side input 400, the transmitter circuitry 408, and the first antennas 416 may be disposed on a second layer (not shown).

In some embodiments, one or more of the client-side input 400, the transmitter circuitry 408, and the first antennas 416 may be integrated into a monolithic semiconductor die (not shown). In some embodiments, one or more of the client-side input 400, the transmitter circuitry 408, and the first antennas 416 may implemented using one or more of complementary metal-oxide semiconductor (CMOS) technology, silicon-germanium (SiGe) semiconductor technology, and III-V compound semiconductor technology.

In some embodiments, the baseband signals 404 are digital bitstreams. In some embodiments, the client data may be encoded in the baseband signals 404 using an encoding protocol conforming to requirements of one or more of return-to-zero (RZ) code, non-return-to-zero (NRZ) code, pulse-amplitude modulation (PAM), and quadrature-amplitude modulation (QAM). In some embodiments, the client data may be encoded in the radiated signals 420 using an encoding protocol conforming to requirements of one or more of RZ, NRZ, quadrature phase-shift keying (QPSK), QAM, trellis coded modulation (TCM), and Bose-Chaudhuri-Hocquenghem (BCH) code.

In some embodiments, the radiated signals 420 include a first complementary radiated signal (not shown) having a first polarization and a second complementary radiated signal (not shown) having a second polarization different from the first polarization. In such embodiments, the first antennas 416 may be configured to generate the radiated signals 420 including the first complementary radiated signal and the second complementary radiated signal based on the antenna feed signals 412. The first polarization and the second polarization may be orthogonal to each other.

In some embodiments, each of the first polarization and the second polarization may be a linear polarization. In such embodiments, the first antennas 416 may include one or more of a differential waveguide probe antenna, a differential tapered antenna, and a differential patch antenna. In other embodiments, each of the first polarization and the second polarization may be a circular polarization. In such embodiments, the first antennas 416 may include one or more of a helix antenna and a spiral antenna. It should be understood that any of the signals described herein may be single-ended signals or differential signals.

In some embodiments, the radiated signals 420 include a first complementary radiated signal (not shown) having a first polarization and a second complementary radiated signal (not shown) having a second polarization different from the first polarization, and the first antennas 416 are further configured to couple the first complementary radiated signal and the second complementary radiated signal into the first hollow waveguide 208a such that the first complementary radiated signal and the second complementary radiated signal interact in the first hollow waveguide 208a to form the combined radiated signal (not shown) having a third polarization different from the first polarization and the second polarization. In such embodiments, the first antennas 416 may include an antenna array.

Referring now to FIG. 4B, in some embodiments, the first transmitter 212a (and, therefore, any of the transmitters 212) further comprises a first serializer 426 configured to receive a plurality of parallel baseband signals 428a-n (hereinafter, the “parallel baseband signals 428”) and combine the parallel baseband signals 428 into a serial baseband signal (i.e., the baseband signals 404). In such embodiments, the client-side input 400 may be configured to receive the baseband signals 404 from the first serializer 426. In some such embodiments, combining the parallel baseband signals 428 into the baseband signals 404 utilizes at least one of polarization division multiplexing (PDM), time division multiplexing (TDM), and wavelength division multiplexing (WDM).

Referring now to FIG. 4C, in some embodiments, the first transmitter 212a (and, therefore, any of the transmitters 212) further comprises a first deserializer 432 configured to receive a serial baseband signal (i.e., the baseband signals 404) and split the baseband signals 404 into parallel baseband signals 428. In such embodiments, the client-side input 400 may be configured to receive the parallel baseband signals 428 from the first deserializer 432. In some such embodiments, splitting the baseband signals 404 into the parallel baseband signals 428 utilizes at least one of PDM, TDM, and WDM.

Referring now to FIG. 4D, shown therein is an exemplary embodiment of the transmitter circuitry 408 shown in FIGS. 4A-4C. In some embodiments, the transmitter circuitry 408 comprises one or more local oscillators 436a-n (hereinafter, the “LO 436”) configured to generate one or more carrier signals 440 (hereinafter, the “carrier signals 440”) having a baseband frequency less than the transmission frequency, one or more modulation circuits 444 (hereinafter, the “modulator 444”) configured to receive the baseband signals 404 from the client-side input 400 and the carrier signals 440 from the LO 436 and modulate the baseband signals 404 onto the carrier signals 440 to generate one or more modulated signals 448 (hereinafter, the “modulated signals 448”), and one or more up-conversion circuits 452 (hereinafter, the “up-convertor 452”) configured to receive the modulated signals 448 from the modulator 444 and up-convert the modulated signals 448 (i.e., raise a frequency of the modulated signals 448 from the baseband frequency to the transmission frequency) to generate the antenna feed signals 412.

Referring now to FIG. 4E, in embodiments in which the client-side input 400 is configured to receive the parallel baseband signals 428, the transmitter circuitry 408 may be configured to receive the parallel baseband signals 428 from the client-side input 400. In such embodiments, the modulator 444 may be configured to receive the parallel baseband signals 428 from the client-side input 400 and the carrier signals 440 from first LO 436 and modulate the parallel baseband signals 428 onto the carrier signals 440 to generate the modulated signals 448. In such embodiments, the up-converter 452 may be configured to receive the modulated signals 448 from the modulator 444 and up-convert the modulated signals 448 to generate one or more up-converted signals 460 (hereinafter, the “up-converted signals 460”).

In some embodiments, the transmitter circuitry 408 may further comprise a combiner 456 configured to receive the up-converted signals 460 from the up-converter 452 and combine the up-converted signals 460 into the antenna feed signals 412. However, in other embodiments, the first antennas 416 may be configured to receive the antenna feed signals 412 from the up-converter 452, generate the radiated signals 420 based on the antenna feed signals 412, and couple the radiated signals 420 into the first hollow waveguide 208a such that the radiated signals 420 interact in the first hollow waveguide 208a to form a combined radiated signal (not shown).

In some embodiments, coupling the radiated signals 420 into the first hollow waveguide 208a such that the radiated signals 420 interact in the first hollow waveguide 208a to form the combined radiated signal utilizes at least one of PDM, TDM, and WDM.

Referring now to FIG. 4F, shown therein is a block diagram of another exemplary embodiment of the first transmitter 212a shown in FIG. 2. However, it should be understood that the description of any particular one of the transmitters 212 may be applicable to any of the transmitters 212 described herein.

In the embodiment shown in FIG. 4F, the first transmitter 212a comprises the client-side input 400 configured to receive the baseband signals 404 from one or more external components (e.g., a control module 224) and send the baseband signals 404 to the transmitter circuitry 408, the transmitter circuitry 408 configured to receive the baseband signals 404 from the client-side input 400, generate the antenna feed signals 412 based on the baseband signals 404, and send the antenna feed signals 412 to an RF interface 464 configured to receive the antenna feed signals 412 from the transmitter circuitry 408 and transmit the antenna feed signals 412, and a digital enhancement and control unit 468 configured to provide digital control and/or processing capabilities for one or more of the components of the first transmitter 212a.

In the embodiment shown in FIG. 4F, the transmitter circuitry 408 comprises one or more modulation blocks 444a (hereinafter, the “modulation block 444a”), a frequency synthesizer 472 comprising a phase-locked loop (PLL) 476 and a first LO 436a, a second LO 436b, a first frequency mixer 480a, a second frequency mixer 480b, a first amplifier 484a, and a second amplifier 484b.

The modulation block 444a may be configured to receive the baseband signals 404 from the client-side input 400 and encode the baseband signals 404 in a format suitable for modulation onto a carrier signal. In some embodiments, the modulation block 444a may include one or more digital-to-analog converters (DAC), one or more Serializer/Deserializers (SerDes), one or more folded modulators 700 (shown in FIG. 7), and/or circuitry operable to encode the baseband signals 404 in a modulation format, such as AM, ASK, PSK, QAM, QAM16, or variations thereof, for example. In some embodiments, the modulation block 444a may include circuitry operable to perform forward error correction (FEC). The modulation block 444a may be further configured to send the encoded input signals having the data encoded therein to the second frequency mixer 480b.

In some embodiments, the modulation block 444a is configured to simply receive the baseband signals 404 (i.e., the baseband signals 404 having been previously encoded in a modulation format) from the client-side input 400 and send the baseband signals 404 to the second frequency mixer 480b.

The second LO 436b may be configured to generate second carrier signals having a continuous waveform (e.g., a sinusoidal waveform) having a predetermined frequency (i.e., a baseband (BB) frequency). In some embodiments, the predetermined frequency of the second carrier signals (i.e., the BB frequency) is in an RF band (i.e., in a range between 30 Hertz (Hz) and 300 GHz). In some embodiments, the predetermined frequency of the second carrier signals (i.e., the BB frequency) is in a range between 1 Megahertz (MHz) and 300 GHz. In some embodiments, the predetermined frequency of the second carrier signals (i.e., the BB frequency) is in a range between 5 GHz and 30 GHz. The second LO 436b may be further configured to send the second carrier signals to the second frequency mixer 480b.

The second frequency mixer 480b may be configured to receive the encoded baseband signals from the modulation block 444a, receive the second carrier signals from the second LO 436b, up-convert the encoded baseband signals with the second carrier signals to produce first modulated signals having client data encoded therein and having the predetermined frequency of the second carrier signals (i.e., the BB frequency), and send the first modulated signals to the third amplifier 484c.

The third amplifier 484c may be configured to receive the first modulated signals from the second frequency mixer 480b, adjust an amplitude of the first modulated signals such that the amplified first modulated signals can drive the first frequency mixer 480a, and send the amplified first modulated signals to the first frequency mixer 480a.

The frequency synthesizer 472 (i.e., the first LO 436a and the PLL 476) may be configured to generate first carrier signals having a continuous waveform (e.g., a sinusoidal waveform) having a predetermined frequency (e.g., within the THz frequency band 104 or, in some embodiments, in a range between 300 GHz and 10 THz). In some embodiments, the predetermined frequency of the first carrier signals is in a range between 30 GHz and 300 GHz. In some such embodiments, the predetermined frequency of the first carrier signals is 240 GHz. In other embodiments, the predetermined frequency of the first carrier signals is in a range between 300 GHz and 3 THz. The frequency synthesizer 472 may be further configured to send the first carrier signals to the second amplifier 484b.

The second amplifier 484b may be configured to receive the first carrier signals from the first LO 436a, adjust an amplitude of the first carrier signals to generate amplified carrier signals that can drive the first frequency mixer 480a, and send the amplified carrier signals to the first frequency mixer 480a.

The first frequency mixer 480a may be configured to receive the amplified carrier signals from the second amplifier 484b, receive the amplified first modulated signals from the third amplifier 484c, up-convert the amplified first modulated signals with the amplified carrier signals to produce second modulated signals having the client data encoded therein and having the predetermined frequency of the amplified carrier signals (i.e., within the THz frequency band 104 or, in some embodiments, in a range between 300 GHz and 10 THz), and send the second modulated signals to the first amplifier 484a.

The first amplifier 484a may be configured to receive the second modulated signals from the first frequency mixer 480a, adjust an amplitude of the second modulated signals such that the amplified second modulated signals can be transmitted by the RF interface 464, and send the amplified second modulated signals to the RF interface 464. The first amplifier 484a may be configured to generate the amplified second modulated signals to have a power in a range between 0.05 watts (W) and 0.4 W, for example.

The RF interface 464 may be configured to receive the amplified second modulated signals with the client data encoded therein from the first amplifier 484a and send the amplified second modulated signals as the antenna feed signals 412 (i.e., having the client data encoded therein) within a predetermined frequency range (e.g., the THz frequency band 104 or, in some embodiments, in a range between 300 GHz and 10 THz). In some embodiments, the RF interface 464 may be electrically connected to one of the first antennas 416 and configured to send the antenna feed signals 412 to the first antenna 416. In other embodiments, however, the first antennas 416 may be included in place of the RF interface 464.

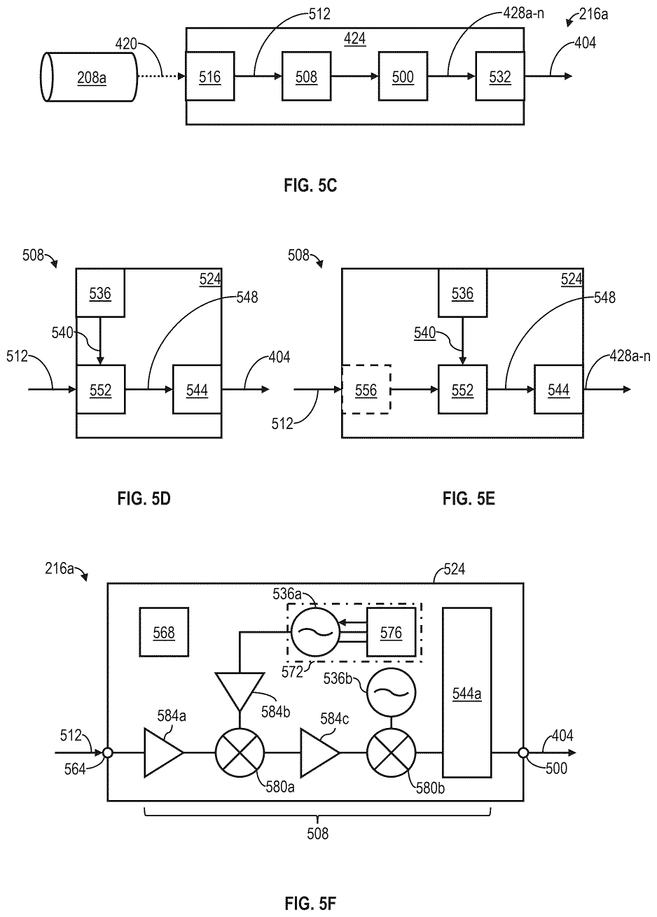

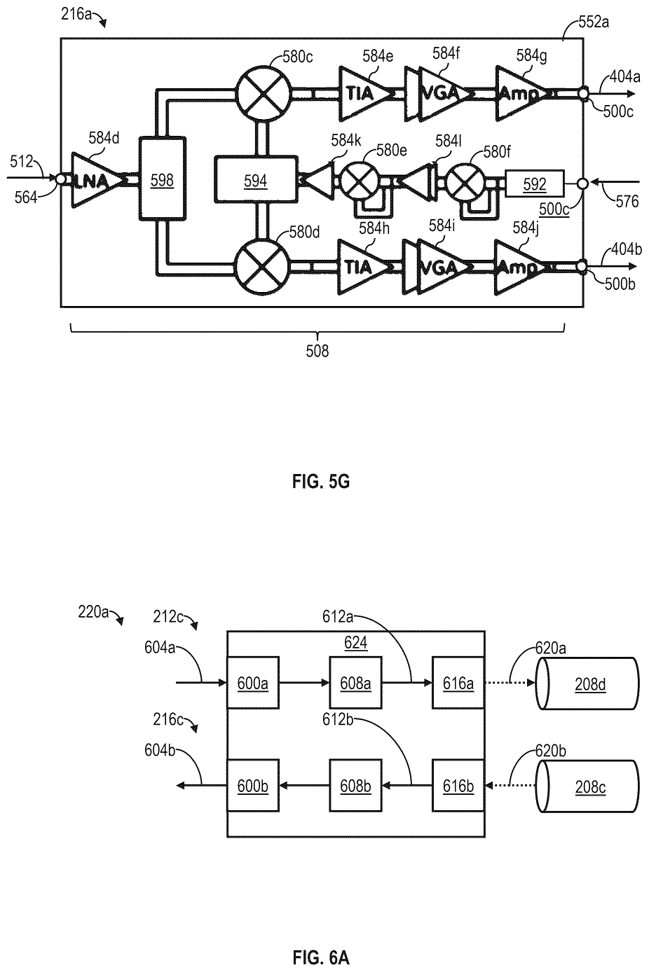

Referring now to FIG. 4G, shown therein is a block diagram of another exemplary embodiment of the first transmitter 212a shown in FIG. 2. In the embodiment shown in FIG. 5B, the first transmitter 212a comprises a plurality of inputs including an in-phase (I)-BB client-side input 400a and a quadrature (Q)-BB client-side input 400b configured to receive I-BB baseband signals 404a and Q-BB baseband signals 404b, respectively, from one or more external components (e.g., a control module 224) and an LO input 400c configured to receive one or more carrier signals 488 (hereinafter, the “carrier signals 488”) from an external LO, the transmitter circuitry 408 configured to generate the antenna feed signals 412 based on the I-BB baseband signals 404a, the Q-BB baseband signals 404b, and the carrier signals 488, and the RF interface 464 configured to transmit the antenna feed signals 412.

In the embodiment shown in FIG. 4G, the transmitter circuitry 408 comprises a balancing unit (Balun) 492, a third frequency mixer 480c, a fourth frequency mixer 480d, a fifth frequency mixer 480e, and a sixth frequency mixer 480f, a fourth amplifier 484d, a fifth amplifier 484e, a sixth amplifier 484f, a seventh amplifier 484g, and eighth amplifier 484h, a quadrature coupler (e.g., branchline coupler) 494, and a power combiner (e.g., Wilkinson power combiner) 498.

The I-BB baseband signals 404a and the Q-BB baseband signals 404b may be I and Q components of baseband signals 404 having client data encoded therein. The I-BB client-side input 400a may be configured to send the I-BB baseband signals 404a to the sixth amplifier 484f. The Q-BB client-side input 400b may be configured to send the Q-BB baseband signals 404b to the seventh amplifier 484g.

The LO input 400c may be configured to receive the carrier signals 488 from an external LO, the carrier signals 488 having a continuous waveform (e.g., a sinusoidal waveform) having a predetermined frequency. The LO input 400c may be further configured to send the carrier signals 488 to the Balun 492.

The Balun 492 may be configured to isolate and/or maintain impedance differences between balanced transmission lines and unbalanced transmission lines. The Balun 492 may be further configured to send the carrier signals 488 to the third frequency mixer 480c.

The third frequency mixer 480c may be configured to receive the carrier signals 488 from the Balun 492, multiply the carrier signals 488 (e.g., by a multiple of four), and send the multiplied carrier signals to the fourth amplifier 484d.

The fourth amplifier 484d may be configured to receive the multiplied carrier signals from the third frequency mixer 480c, adjust an amplitude of the multiplied carrier signals such that the amplified carrier signals can drive the fourth frequency mixer 480d, and send the amplified carrier signals to the fourth frequency mixer 480d.

The fourth frequency mixer 480d may be configured to receive the amplified carrier signals from the fourth amplifier 484d, multiply the amplified carrier signals (e.g., by a multiple of two), and send the remultiplied carrier signals to the fifth amplifier 484e.

The fifth amplifier 484e may be configured to receive the remultiplied carrier signals from the fourth frequency mixer 480d, adjust an amplitude of the remultiplied carrier signals such that the reamplified carrier signals can drive the quadrature coupler 494, and send the reamplified carrier signals to the quadrature coupler 494.

The sixth amplifier 484f may be configured to receive the I-BB baseband signals 404a from the I-BB client-side input 400a, adjust an amplitude of the I-BB baseband signals 404a such that the amplified I-BB input signals can drive the fifth frequency mixer 480e, and send the amplified I-BB signals to the fifth frequency mixer 480e.

The seventh amplifier 484g may be configured to receive the Q-BB baseband signals 404b from the Q-BB client-side input 400b, adjust an amplitude of the Q-BB baseband signals 404b such that the amplified Q-BB baseband signals 404b can drive the sixth frequency mixer 480f, and the amplified Q-BB signals to the sixth frequency mixer 480f.

The quadrature coupler 494 may be configured to receive the reamplified carrier signals from the fifth amplifier 484e, split the reamplified carrier signals into first carrier signals and second carrier signals, send the first carrier signals to the fifth frequency mixer 480e, and send the second carrier signals to the sixth frequency mixer 480f, wherein the first carrier signals and the second carrier signals are out of phase by 90°.

The fifth frequency mixer 480e may be configured to receive the amplified I-BB signals from the sixth amplifier 484f, receive the first carrier signals from the quadrature coupler 494, up-convert the amplified I-BB signals with the first carrier signals to produce I antenna feed signals having the I component of the client data encoded therein and having the predetermined frequency of the carrier signals 488, and send the I antenna feed signals to the power combiner 498.

The sixth frequency mixer 480f may be configured to receive the amplified Q-BB signals from the seventh amplifier 484g, receive the second carrier signals from the quadrature coupler 494, up-convert the amplified Q-BB signals with the second carrier signals to produce Q antenna feed signals having the Q component of the client data encoded therein and having the predetermined frequency of the carrier signals 488, and send the Q antenna feed signals to the power combiner 498.

The power combiner 498 may be configured to receive the I antenna feed signals from the fifth frequency mixer 480e, receive the Q antenna feed signals from the sixth frequency mixer 480f, combine the I antenna feed signals and the Q antenna feed signals to produce the antenna feed signals 412, and send the antenna feed signals 412 to the RF interface 464. In some embodiments, the RF interface 464 may be electrically connected to one of the first antennas 416 and configured to send the antenna feed signals 412 to the first antenna 416. In other embodiments, however, one of the first antennas 416 may be included in place of the RF interface 464.

Referring now to FIG. 5A, shown therein is a block diagram of an exemplary embodiment of the first receiver 216a (hereinafter, the “first receiver 216a”) shown in FIG. 2. However, it should be understood that the description of any particular one of the receivers 216 may be applicable to any of the receivers 216 described herein. The first receiver 216a (and, therefore, each of the receiver 216) generally comprises one or more second antennas 516 configured to detect the radiated signals 420 received from the first hollow waveguide 208a and generate one or more antenna output signals 512 (hereinafter, the “antenna output signals 512”) based on the radiated signals 420, receiver circuitry 508 configured to receive the antenna output signals 512 from the second antennas 516 and generate the baseband signals 404 based on the antenna output signals 512, and a client-side output 500 configured to receive the baseband signals 404 from the receiver circuitry 508 and transmit the baseband signals 404 to one or more external components (e.g., a control module 224).

In some embodiments, the antenna output signals 512 are received from the second antennas 516 on one or more transmission lines (not shown) (hereinafter, the “transmission lines”), wherein each of the transmission lines has two or more conductors (not shown) (hereinafter, the “conductors”). In some embodiments, the transmission lines have a first transmission loss and the first hollow waveguide 208a has a second transmission loss that is less than the first transmission loss. In some embodiments, the second transmission loss is in a range between 0.001 and 20.00 dB/m/Tb/s.

In some embodiments, as shown in FIG. 5A, each of the second antennas 516, the receiver circuitry 508, and the client-side output 500 may be disposed on a substrate 524. However, in other embodiments, one or more of the second antennas 516, the receiver circuitry 508, and the client-side output 500 may be disposed on a first substrate (not shown), and one or more of the second antennas 516, the receiver circuitry 508, and the client-side output 500 may not be disposed on the first substrate. For example, the one or more of the second antennas 516, the receiver circuitry 508, and the client-side output 500 may be disposed on a second substrate (not shown). In such embodiments, the first substrate and the second substrate may be in a stacked arrangement.

In some embodiments, the substrate 524 may have a plurality of layers (not shown). In such embodiments, one or more of the second antennas 516, the receiver circuitry 508, and the client-side output 500 may be disposed on a first layer (not shown), and one or more of the second antennas 516, the receiver circuitry 508, and the client-side output 500 may be disposed on a second layer (not shown).

In some embodiments, one or more of the second antennas 516, the receiver circuitry 508, and the client-side output 500 may be integrated into a monolithic semiconductor die (not shown). In some embodiments, one or more of the second antennas 516, the receiver circuitry 508, and the client-side output 500 may implemented using one or more of CMOS technology, SiGe semiconductor technology, and III-V compound semiconductor technology.

In some embodiments, the radiated signals 420 include a first complementary radiated signal (not shown) having a first polarization and a second complementary radiated signal (not shown) having a second polarization different from the first polarization. In such embodiments, the second antennas 516 may be configured to generate the antenna output signals 512 based on the radiated signals 420 including the first complementary radiated signal and the second complementary radiated signal. The first polarization and the second polarization may be orthogonal to each other.

In some embodiments, the radiated signals 420 may be formed by a first complementary radiated signal (not shown) having a first polarization and a second complementary radiated signal (not shown) having a second polarization different from the first polarization interacting in the first hollow waveguide 208a. In such embodiments, the radiated signals 420 may have a third polarization different from the first polarization and the second polarization. In such embodiments, the second antennas 516 may be configured generate the antenna output signals 512 based on the radiated signals 420 formed by the first complementary radiated signal and the second complementary radiated signal.

Referring now to FIG. 5B, in some embodiments, the client-side output 500 is configured to receive a serial baseband signal (i.e., the baseband signals 404) from the receiver circuitry 508. In such embodiments, the first receiver 216a (and, therefore, any of the receivers 216) may further comprise a second deserializer 526 configured to receive the baseband signals 404 from the client-side output 500, split the serial baseband signal into the parallel baseband signals 428, and transmit the parallel baseband signals 428 to one or more external components (e.g., a control module 224). In some such embodiments, splitting the serial baseband signal into the parallel baseband signals 428 utilizes at least one of PDM, TDM, and WDM.

Referring now to FIG. 5C, in some embodiments, the client-side output 500 is configured to receive the parallel baseband signals 428 from the receiver circuitry 508. In such embodiments, the first receiver 216a (and, therefore, any of the receivers 216) may further comprise a second serializer 532 configured to receive the parallel baseband signals 428 from the client-side output 500 and combine the parallel baseband signals 428 into the serial baseband signal (i.e., the baseband signals 404). In some such embodiments, combining the parallel baseband signals 428 into the baseband signals 404 utilizes at least one of PDM, TDM, and WDM.

Referring now to FIG. 5D, shown therein is an exemplary embodiment of the receiver circuitry 508 shown in FIGS. 5A-5C. In some embodiments, the receiver circuitry 508 comprises one or more LOs 536 (hereinafter, the “LO 536”) configured to generate one or more reference signals 540 (hereinafter, the “reference signals 540”) having a baseband frequency less than the transmission frequency, one or more down-conversion circuits 552 (hereinafter, the “down-converter 552”) configured to receive the antenna output signals 512 from the second antennas 516 and the reference signals 540 from the LO 536 and down-convert the antenna output signals 512 (i.e., lower a frequency of the antenna output signals 512 from the transmission frequency to the baseband frequency) using the reference signals 540 to generate one or more modulated signals 548 (hereinafter, the “modulated signals 548”), and one or more demodulation circuits 544 (hereinafter, the “demodulator 544”) configured to receive the modulated signals 548 from the down-converter 552 and demodulate the modulated signals 548 to generate the baseband signals 404.

Referring now to FIG. 5E, in embodiments in which the second antennas 516 are configured to receive the radiated signals 420 formed by a first complementary radiated signal (not shown) having a first polarization and a second complementary radiated signal (not shown) having a second polarization different from the first polarization interacting in the first hollow waveguide 208a, the receiver circuitry 508 may be configured to receive the antenna output signals 512 from the second antennas 516. In such embodiments, the demodulator 544 may be configured to receive the modulated signals 548 from the down-converter 552 and demodulate the modulated signals 548 to generate the parallel baseband signals 428.

In some embodiments, the receiver circuitry 508 may further comprise a splitter 556 configured to receive the antenna output signals 512 from the second antennas 516 and split the antenna output signals 512 into a plurality of parallel antenna output signals 560 (hereinafter, the “parallel antenna output signals 560”). However, in other embodiments, the second antennas 516 may be configured to detect the first complementary radiated signal and the second complementary radiated signal based on the radiated signals 420 received from the first hollow waveguide 208a and generate the antenna output signals 512 based on the first complementary radiated signal and the second complementary radiated signal.

In some embodiments, detecting the first complementary radiated signal and the second complementary radiated signal based on the radiated signals 520 received from the first hollow waveguide 208a utilizes at least one of PDM, TDM, and WDM.

Referring now to FIG. 5F, shown therein is a block diagram of another exemplary embodiment of the first receiver 216a shown in FIG. 2. In the embodiment shown in FIG. 5F, the first receiver 216a comprises an RF interface 564 configured to receive the antenna output signals 512, the receiver circuitry 508 configured to generate the baseband signals 404 based on the antenna output signals 512, the client-side output 500 configured to transmit the baseband signals 404 to one or more external components (e.g., a control module 224), and a digital enhancement and control unit 568 configured to provide digital control and/or processing capabilities for one or more of the components of the first receiver 216a.

In the embodiment shown, the receiver circuitry 508 comprises one or more demodulation blocks 544a (hereinafter, the “demodulation block 544a”), a frequency synthesizer 572 comprising a PLL 576 and a first LO 536a, a second LO 536b, a first frequency mixer 580a, a second frequency mixer 580b, a first amplifier 584a, a second amplifier 584b, and a third amplifier 584c.

The RF interface 564 may be configured to send the antenna output signals 512 to the first amplifier 584a. In some embodiments, the RF interface 564 may be configured to receive the antenna output signals 512 from one of the second antennas 516. In other embodiments, one of the second antennas 516 may be included in place of the RF interface 564.

The first amplifier 584a may be configured to receive the antenna output signals 512 from the RF interface 564, adjust an amplitude of the antenna output signals 512 such that the amplified transmission signals can drive the first frequency mixer 580a, and send the amplified transmission signals to the first frequency mixer 580a.

The frequency synthesizer 572 (i.e., the first LO 536a and the PLL 576) may be configured to generate first carrier signals having a continuous waveform (e.g., a sinusoidal waveform) having a predetermined frequency (e.g., within the THz frequency band 104 or, in some embodiments, in a range between 300 GHz and 10 THz). In some embodiments, the predetermined frequency of the first carrier signals is in a range between 30 GHz and 300 GHz. In some such embodiments, the predetermined frequency of the first carrier signals is 240 GHz. In other embodiments, the predetermined frequency of the first carrier signals is in a range between 300 GHz and 3 THz. The first LO 536a may be further configured to send the first carrier signals to the second amplifier 584b.

The second amplifier 584b may be configured to receive the first carrier signals from the first LO 536a, adjust an amplitude of the first carrier signals to generate amplified carrier signals that can drive the first frequency mixer 580a, and send the amplified carrier signals to the first frequency mixer 580a.

The first frequency mixer 580a may be configured to receive the antenna output signals 512 from the first amplifier 584a, receive the amplified carrier signals from the second amplifier 584b, down-convert the antenna output signals 512 with the amplified carrier signals to produce modulated signals having the client data encoded therein and having the BB frequency, and send the modulated signals to the third amplifier 584c.

The third amplifier 584c may be configured to receive the modulated signals from the first frequency mixer 580a, adjust an amplitude of the modulated signals such that the amplified modulated signals can drive the second frequency mixer 580b, and send the amplified modulated signals to the second frequency mixer 580b.

The second LO 536b may be configured to generate second carrier signals having a continuous waveform (e.g., a sinusoidal waveform) having a predetermined frequency (i.e., the BB frequency). In some embodiments, the predetermined frequency of the second carrier signals (i.e., the BB frequency) is in a range between 8 GHz and 10 GHz. The second LO 536b may be further configured to send the second carrier signals to the second frequency mixer 580b.

The second frequency mixer 580b may be configured to receive the amplified modulated signals from the third amplifier 584c, receive the second carrier signals from the second LO 536b, down-convert the amplified modulated signals with the second carrier signals to produce encoded signals having the client data encoded therein and having the predetermined frequency of the second carrier signals (i.e., the BB frequency), and send the encoded signals to the demodulation block 544a.

The demodulation block 544a may be configured to receive the encoded signals from the second frequency mixer 580b and decode the encoded signals in a format suitable for transmission to one or more external components (e.g., a control module 224) to generate the baseband signals 404.

In some embodiments, the demodulation block 544a may include one or more analog-to-digital converters (ADC), one or more Serializer/Deserializers (SerDes), one or more rectifying detectors 800 (shown in FIG. 8), and/or circuitry operable to decode the encoded output signals from a modulation format, such as AM, ASK, PSK, QAM, or QAM16, or variations thereof, for example, to produce the baseband signals 404 with the client data encoded therein. In some embodiments, the demodulation block 544a may include circuitry operable to perform forward error correction (FEC). The demodulation block 544a may be further configured to send the baseband signals 404 to the client-side output 500. In some embodiments, the demodulation block 544a is configured to simply receive the encoded signals from the second frequency mixer 580b and send the encoded signals as the baseband signals 404 to the client-side output 500.

In some embodiments, the client-side output 500 is a pair of output interfaces. In some such embodiments, the client-side output 500 is an LVDS link configured to transmit LVDS signals, and the baseband signals 404 are LVDS signals with the client data encoded therein.

Referring now to FIG. 5G, shown therein is a block diagram of another exemplary embodiment of the first receiver 216a shown in FIG. 2. In the embodiment shown in FIG. 5G, the first receiver 216a comprises the RF interface 564 configured to receive the antenna output signals 512, an LO input 500c configured to receive carrier signals 588 from an external LO, the receiver circuitry 508 configured to generate Q-BB baseband signals 404b and I-BB baseband signals 404a based on the antenna output signals 512 and the carrier signals 588, and a Q-BB client-side output 500a and an I-BB client-side output 500b configured to transmit the Q-BB baseband signals 404b and the I-BB baseband signals 404a, respectively.

In the embodiment shown, the receiver circuitry 508a comprises a third frequency mixer 580c, a fourth frequency mixer 580d, a fifth frequency mixer 580e, a sixth frequency mixer 580f, a fourth amplifier 584d, a fifth amplifier 584e, a sixth amplifier 584f, a seventh amplifier 584g, an eighth amplifier 584h, a ninth amplifier 584i, a tenth amplifier 584j, an eleventh amplifier 584k, a twelfth amplifier 584l, a Balun 592, a quadrature coupler (e.g., branchline coupler) 594, and a power divider (e.g., Wilkinson power divider) 598.

The fourth amplifier 584d may be configured to receive the antenna output signals 512 from the RF interface 564, adjust an amplitude of the antenna output signals 512 such that the amplified transmission signals can drive the power divider 598, and send the amplified transmission signals to the power divider 598. In some embodiments, the fourth amplifier 584d is a low-noise amplifier (LNA).

The power divider 598 may be configured to receive the amplified transmission signals from the fourth amplifier 584d, split the amplified transmission signals into I antenna output signals having the I component of the client data encoded therein and Q antenna output signals having the Q component of the client data encoded therein, send the Q antenna output signals to the third frequency mixer 580c, and send the I antenna output signals to the fourth frequency mixer 580d.

The LO input 500c may be configured to receive carrier signals 588 from an external LO, the carrier signals 588 having a continuous waveform (e.g., a sinusoidal waveform) having a predetermined frequency. The LO input 500c may be further configured to send the carrier signals 588 to the Balun 592.

The Balun 592 may be configured to isolate and/or maintain impedance differences between balanced transmission lines and unbalanced transmission lines. The Balun 492 may be further configured to send the carrier signals 588 to the sixth frequency mixer 580f.

The sixth frequency mixer 580f may be configured to receive the carrier signals 588 from the Balun 592, multiply the carrier signals 588 (e.g., by a multiple of four), and send the multiplied carrier signals to the twelfth amplifier 584l.

The twelfth amplifier 584l may be configured receive the multiplied carrier signals from the sixth frequency mixer 580f, adjust an amplitude of the multiplied carrier signals to generate amplified carrier signals that can drive the fifth frequency mixer 580e, and send the amplified carrier signals to the fifth frequency mixer 580e.

The fifth frequency mixer 580e may be configured to receive the amplified carrier signals from the twelfth amplifier 584l, multiply the amplified carrier signals (e.g., by a multiple of two), and send the remultiplied carrier signals to the eleventh amplifier 584k.

The eleventh amplifier 584k may be configured to receive the remultiplied carrier signals from the fifth frequency mixer 580e, adjust an amplitude of the remultiplied carrier signals to generate reamplified carrier signals that can drive the quadrature coupler 594, and send the reamplified carrier signals to the quadrature coupler 594.

The quadrature coupler 594 may be configured to receive the reamplified carrier signals from the eleventh amplifier 584k, split the reamplified carrier signals into first carrier signals and second carrier signals, send the first carrier signals to the third frequency mixer 580c, and send the second carrier signals to the fourth frequency mixer 580d, wherein the first carrier signals and the second carrier signals are out of phase by 90°.

The third frequency mixer 580c may be configured to receive the Q antenna output signals from the power divider 598, receive the first carrier signals from the quadrature coupler (e.g., branchline coupler) 566, down-convert the Q antenna output signals with the first carrier signals to generate Q-BB intermediate signals having the Q component of the client data encoded therein and having the BB frequency, and send the Q-BB intermediate signals to the fifth amplifier 584e.

The fifth amplifier 584e, the sixth amplifier 584f, and the seventh amplifier 584g may be configured to receive the Q-BB intermediate signals from the third frequency mixer 580c, down-convert the Q-BB intermediate signals to generate the Q-BB baseband signals 404b, and send the Q-BB baseband signals 404b to the Q-BB client-side output 500a. In some embodiments, the fifth amplifier 584e is a transimpedance amplifier (TIA), and the sixth amplifier 584f is a variable-gain amplifier (VGA).

The fourth frequency mixer 580d may be configured to receive the I antenna output signals from the power divider 598, receive the second carrier signals from the quadrature coupler 594, down-convert the I antenna output signals with the second carrier signals to produce I-BB intermediate signals having the I component of the client data encoded therein and having the BB frequency, and send the I-BB intermediate signals to the eighth amplifier 584h.

The eighth amplifier 584h, the ninth amplifier 584i, and the tenth amplifier 584j may be configured to receive the I-BB intermediate signals from the fourth frequency mixer 580d, down-convert the I-BB intermediate signals to generate the I-BB baseband signals 404a, and send the I-BB baseband signals 404a to the I-BB client-side output 500b. In some embodiments, the eighth amplifier 584h is a TIA, and the ninth amplifier 584i is VGA.

Referring now to FIG. 6A, shown therein is a block diagram of an exemplary embodiment of the first transceiver 220a (hereinafter, the “first transceiver 220a”) shown in FIG. 2. However, it should be understood that the description of any particular one of the transceivers 220 may be applicable to any of the transceivers 220 described herein. The first transceiver 220a (and, therefore, each of the transceivers 220) generally comprises a third transmitter 212c and a third receiver 216c.

The third transmitter 212c generally comprises a client-side input 600a configured to receive one or more first baseband signals 604a (hereinafter, the “first baseband signals 604a”) having first client data encoded therein from one or more external components (e.g., a control module 224), transmitter circuitry 608a configured to receive the first baseband signals 604a from the client-side input 600a and generate one or more antenna feed signals 612a (hereinafter, the “antenna feed signals 612”) based on the first baseband signals 604a, and one or more first antennas 616a (hereinafter, the “first antennas 616”) configured to receive the antenna feed signals 612a from the transmitter circuitry 608a, generate one or more first radiated signals 420a (hereinafter, the “first radiated signals 420a”) based on the antenna feed signals 612a, and couple the first radiated signals 420a into the fourth hollow waveguide 208d.

The third receiver 216c generally comprises one or more second antennas 616b (hereinafter, the “antennas 616b”) configured to detect one or more second radiated signals 620b (hereinafter, the “second radiated signals 620b”) received from the third hollow waveguide 208c and generate one or more antenna output signals 612b (hereinafter, the “antenna output signals 612b”) based on the second radiated signals 620b, receiver circuitry 608b configured to receive the antenna output signals 612b from the second antennas 616b and generate the second baseband signals 604b based on the antenna output signals 612b, and a client-side output 600b configured to receive the second baseband signals 604b from the receiver circuitry 608b and transmit the second baseband signals 604b to one or more external components (e.g., a control module 224).

Each of the components of the first transceiver 220a (and, therefore, each of the transceivers 220) may be the same or similar to one or more of the components of the first transmitter 212a and the first receiver 216a as described herein.

Referring now to FIG. 6B, shown therein is a block diagram of another exemplary embodiment of the first transceiver 220a shown in FIG. 2. In the embodiment shown in FIG. 6B, the first transceiver 220a comprises the client-side input 600a configured to receive the first baseband signals 604a from one or more external components (e.g., a control module 224), the transmitter circuitry 608a configured to generate the antenna feed signals 612a based on the input signals 640a, a first RF interface 664a configured to transmit the antenna feed signals 612a, a second RF interface 664b configured to receive the antenna output signals 612b, the receiver circuitry 608b configured to generate the second baseband signals 604b based on the antenna output signals 612b, the client-side output 600b configured to transmit the second baseband signals 604b to one or more external components, and a digital enhancement and control unit 668 configured to provide digital control and/or processing capabilities for one or more of the components of the first transceiver 220a.

In some embodiments, the first transceiver 220a comprises the first RF interface 664a, but lacks the second RF interface 664b. In such embodiments, the first RF interface 664a may be configured to transmit antenna feed signals 612a and receive antenna output signals 612b. In some embodiments, the first transceiver 220a may have a number of RF interfaces that is greater than two.

In the embodiment shown, the transmitter circuitry 608a comprises a frequency synthesizer 672 comprising a PLL 676, a first LO 636a, and a signal distribution block (e.g., splitter) 698, one or more modulation blocks 644a (hereinafter, the “modulation block 644a”), a second LO 636b, a first frequency mixer 680a, a third frequency mixer 680c, a first amplifier 684a, a third amplifier 684c, and a fifth amplifier 684e.

In the embodiment shown, the receiver circuitry 608b comprises the frequency synthesizer 672 comprising the PLL 676, the first LO 636a, and the signal distribution 698, the modulation block 644a, a third LO 636c, a second frequency mixer 680b, a fourth frequency mixer 680d, a second amplifier 684b, a fourth amplifier 684d, and a sixth amplifier 684f.

In some embodiment shown in FIG. 6B, each of the components of the first transceiver 220a are disposed on a single substrate 624, which may be a portion of a semiconductor wafer.

The modulation block 644a may be configured to: (1) receive the first baseband signals 604a from the client-side input 600a, encode the first baseband signals 604a in a format suitable for modulation onto a carrier signal, and send the encoded input signals the third frequency mixer 680c; and (2) receive the encoded output signals from the fourth frequency mixer 680d, decode the encoded output signals in a format suitable for transmission to one or more external components (e.g., a control module 224), and send the second baseband signals 604b to the client-side output 600b.

In some embodiments, the modulation block 644a may include one or more DACs, one or more ADCs, one or more Serializer/Deserializers (SerDes), one or more folded modulators 700 (shown in FIG. 7), one or more rectifying detectors 800 (shown in FIG. 8) and/or circuitry operable to encode the first baseband signals 604a in a modulation format, such as AM, ASK, PSK, QAM, or QAM16, or variations thereof, for example, and decode encoded output signals from the modulation format to produce second baseband signals 604b having the client data encoded therein. In some embodiments, the modulation block 644a may include circuitry operable to perform forward error correction (FEC).

The frequency synthesizer 672 may be configured to generate first carrier signals having a continuous waveform (e.g., a sinusoidal waveform) having a predetermined frequency (e.g., within the THz frequency band 104 or in some embodiments, a range between 300 GHz and 10 THz). In some embodiments, the predetermined frequency of the first carrier signals is in a range between 30 GHz and 300 GHz. In some such embodiments, the predetermined frequency of the first carrier signals is 240 GHz. In other embodiments, the predetermined frequency of the first carrier signals is in a range between 300 GHz and 3 THz. The frequency synthesizer 672 may be further configured to send the first carrier signals to the signal distribution block 698.

The signal distribution block 698 may be configured to receive the first carrier signals from the first LO 636a and distribute the first carrier signals to the third amplifier 684c and the fourth amplifier 684d.

Referring now to the transmitter circuitry 608a, in some embodiments, the client-side input 600a is a pair of input interfaces. In some such embodiments, the client-side input 600a is an LVDS link configured to receive LVDS signals, and the first baseband signals 604a are LVDS signals having the client data encoded therein. The client-side input 600a may be further configured to send the first baseband signals 604a to the modulation block 644a.

The second LO 636b may be configured to generate second carrier signals having a continuous waveform (e.g., a sinusoidal waveform) having a predetermined frequency (i.e., the BB frequency). In some embodiments, the predetermined frequency of the second carrier signals (i.e., the BB frequency) is in a range between 8 GHz and 10 GHz. The second LO 636b may be further configured to send the second carrier signals to the third frequency mixer 680c.

The third frequency mixer 680c may be configured to receive the encoded input signals from the modulation block 644a, receive the second carrier signals from the second LO 636b, up-convert the encoded input signals with the second carrier signals to produce first modulated signals having the client data encoded therein and having the predetermined frequency of the second carrier signals (i.e., the BB frequency), and send the first modulated signals to the fifth amplifier 684e.

The fifth amplifier 684e may be configured to receive the first modulated signals from the third frequency mixer 680c, adjust an amplitude of the first modulated signals such that the amplified first modulated signals can drive the first frequency mixer 680a, and send the amplified first modulated signals to the first frequency mixer 680a.

The third amplifier 684c may be configured to receive the first carrier signals from the signal distribution block 698, adjust an amplitude of the first carrier signals to generate amplified carrier signals that can drive the first frequency mixer 680a, and send the amplified carrier signals to the first frequency mixer 680a.

The first frequency mixer 680a may be configured to receive the amplified carrier signals from the third amplifier 684c, receive the amplified first modulated signals from the fifth amplifier 684e, up-convert the amplified first modulated signals with the amplified carrier signals to produce second modulated signals having the data encoded therein and having the predetermined frequency of the amplified carrier signals (i.e., within the THz frequency band 104 or, in some embodiments, in a range between 300 GHz and 10 THz), and send the second modulated signals to the first amplifier 684a.

The first amplifier 684a may be configured to receive the second modulated signals from the first frequency mixer 680a, adjust an amplitude of the second modulated signals such that the amplified second modulated signals can be transmitted by the first RF interface 664a, and send the amplified second modulated signals to the first RF interface 664a.

The first RF interface 664a may be configured to receive the amplified second modulated signals from the first amplifier 684a and send the amplified second modulated signals as antenna feed signals 612a (i.e., having the data encoded therein) having a frequency within a predetermined frequency range (e.g., the THz frequency band 104 or, in some embodiments, in a range between 300 GHz and 10 THz). In some embodiments, the first RF interface 664a may be connected to one of the antennas 616 and configured to send the antenna feed signals 612a to the antenna 616. In other embodiments, however, one of the antennas 616 may be included in place of the first RF interface 664a.

Referring now to the receiver circuitry 608b, the second RF interface 664b may be configured to receive the antenna output signals 612b (i.e., having client data encoded therein) within a predetermined frequency range (e.g., the THz frequency band 104 or, in some embodiments, in a range between 300 GHz and 10 THz) and send the antenna output signals 612b to the second amplifier 684b. As described in further detail below, the second RF interface 664b may be configured to receive the antenna output signals 612b from one of the antennas 616. In other embodiments, however, one of the antennas 616 may be included in place of the second RF interface 664b.

The second amplifier 684b may be configured to receive the antenna output signals 612b from the second RF interface 664b, adjust an amplitude of the antenna output signals 612b to generate amplified second transmission signals that can drive the second frequency mixer 680b, and send the amplified second transmission signals to the second frequency mixer 680b.

The fourth amplifier 684d may be configured to receive the first carrier signals from the signal distribution block 698, adjust an amplitude of the first carrier signals to generate amplified carrier signals that can drive the second frequency mixer 680b, and send the amplified carrier signals to the second frequency mixer 680b.

The second frequency mixer 680b may be configured to receive the amplified second transmission signals from the second amplifier 684b, receive the amplified carrier signals from the fourth amplifier 684d, down-convert the amplified second transmission signals with the amplified carrier signals to produce third modulated signals having the data encoded therein and having the IF or the BB frequency, and send the third modulated signals to the sixth amplifier 684f.

The sixth amplifier 684f may be configured to receive the third modulated signals from the second frequency mixer 680b, adjust an amplitude of the third modulated signals such that the amplified third modulated signals can drive the fourth frequency mixer 680d, and send the amplified third modulated signals to the fourth frequency mixer 680d.

The third LO 636c may be configured to generate reference signals having a continuous waveform (e.g., a sinusoidal waveform) having a predetermined frequency (i.e., a BB frequency). In some embodiments, the predetermined frequency of the reference signals (i.e., the BB frequency) is in a range between 8 GHz and 10 GHz. The third LO 636c may be further configured to send the reference signals to the fourth frequency mixer 680d.

The fourth frequency mixer 680d may be configured to receive the amplified third modulated signals from the sixth amplifier 684f, receive the reference signals from the third LO 636c, down-convert the amplified third modulated signals with the reference signals to produce encoded output signals having the client data encoded therein and having the predetermined frequency of the reference signals (i.e., the BB frequency), and send the encoded output signals to the modulation block 644a.

The client-side output 600b may be configured to transmit the second baseband signals 604b having the client data encoded therein to one or more external components (e.g., a control module 224). In some embodiments, the client-side output 600b is a pair of output interfaces. In some such embodiments, the client-side output 600b is an LVDS link configured to transmit LVDS signals, and the second baseband signals 604b are LVDS signals having the client data encoded therein.

Referring now to FIG. 7, shown therein is a schematic diagram of an exemplary embodiment of a folded modulator 700 constructed in accordance the present disclosure. The folded modulator 700 may be configured to perform broadband direct modulation to generate the encoded signals and to minimize distortion while doing so. The folded modulator 700 may employ a cascade architecture (e.g., a cascaded circuit drive that is “stacked” or “folded”) in order to produce a linear or near-linear modulated output (i.e., the encoded signals). In embodiments in which the folded modulator 700 employs a cascade architecture, the size of the stack may be directly proportional to the bandwidth.

Referring now to FIG. 8, shown therein is a schematic diagram of an exemplary embodiment of a rectifying detector 800 constructed in accordance the present disclosure. The rectifying detector 800 may be configured to perform direct detection of incoming signals (i.e., the encoded signals). The rectifying detector 800 may be further configured to detect an envelope of the encoded signals or one or more amplitude transitions of the encoded signals to generate the output signals.

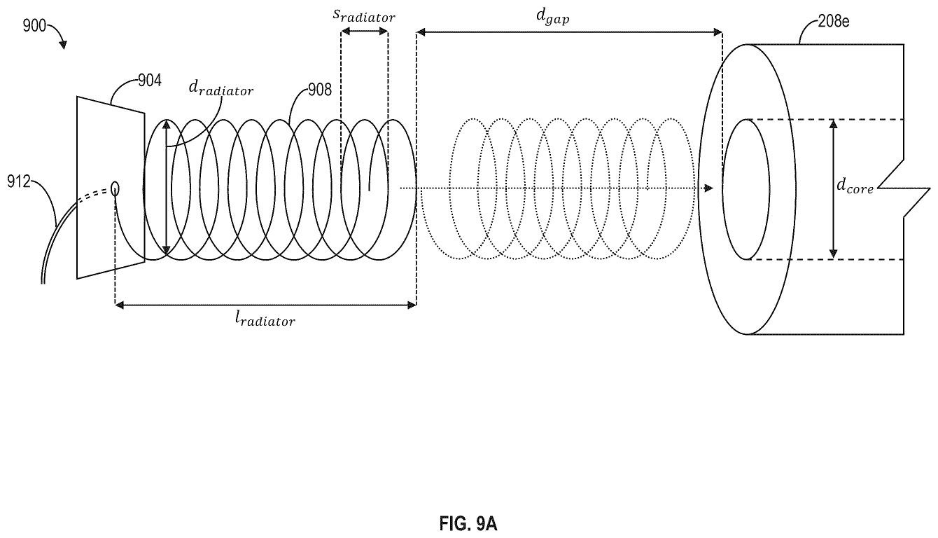

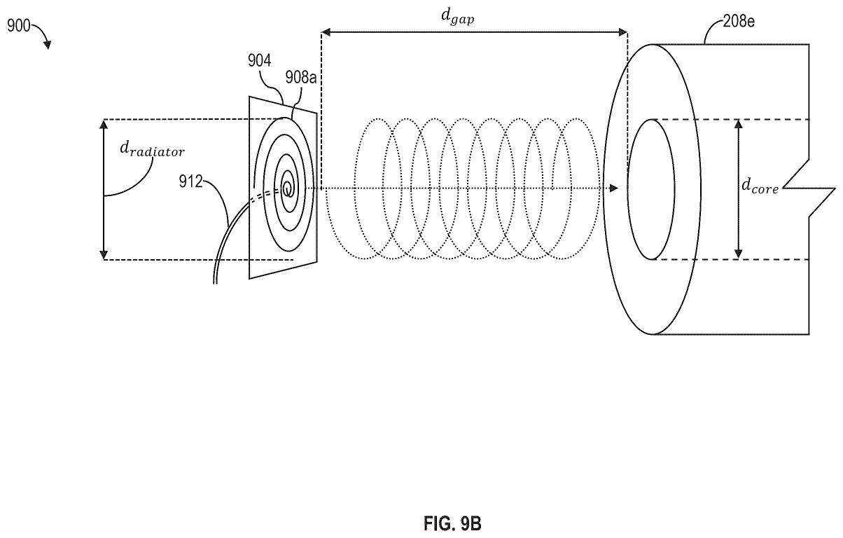

Referring now to FIG. 9A, shown therein is a side view of an exemplary embodiment of an antenna 900 coupled with a fifth hollow waveguide 208e constructed in accordance with the present disclosure. However, it should be understood that the description referring to any particular one of the antennas 416, 516, 616, 900 may refer to any of the antennas 416, 516, 616, 900 described herein. As shown in FIG. 8A, the antenna 900 generally comprises a ground plane 904, a radiator 908 mounted on the ground plane 904, and a coaxial feedline 912 electrically connected to the radiator 908. In some embodiments, the antenna 900 may lack the ground plane 904. In some embodiments, the antenna 900 further comprises a casing (not shown) enclosing the radiator 908. The antenna 900 may be a vertical antenna (i.e., an antenna extending orthogonally from a substrate) or a horizontal antenna (i.e., an antenna extending laterally from a substrate).

The radiator 908 may be configured to transmit and detect radiated signals configured for coherent detection. In the embodiment shown, the radiator 908 is a helical radiator configured to transmit and detect radiated signals having a circular polarization. In this embodiment, the radiator 908 has a length l_{radiator}, a diameter d_{radiator}, and a spacing s_{radiator} between adjacent turns of the radiator 908. The radiator 908 is preferably disposed at a distance d_{gap} from the fifth hollow waveguide 208e.

The radiator 908 may be wound in a predetermined direction, such as clockwise (i.e., a left-hand wind) or counter-clockwise (i.e., a right-hand wind). While the radiator 908 of the antenna 900 is depicted in FIG. 9A as having a right-hand wind or a counter-clockwise rotational direction, it should be understood that the radiator 908 of the antenna 900 may be provided with a left-hand wind or a clockwise rotational direction.

In some embodiments, signals for transmission may be sent to the antenna 900 via the coaxial feedline 912. In other embodiments, received RF signals may be sent from the antenna 900 via the coaxial feedline 912.

In some embodiments, the length l_{radiator} of the radiator 908 may be proportional to the wavelength of the signals being transmitted and/or received. In some embodiments, the length l_{radiator} of the radiator 908 is in a range between 10 microns and 10 mm. In some embodiments, the diameter d_{radiator} of the radiator 908 may be proportional to the wavelength of the signals being transmitted and/or received. In some embodiments, the diameter d_{radiator} of the radiator 908 is in a range between 10 microns and 10 mm. In some embodiments, the spacing s_{radiator} between adjacent turns of the radiator 908 may be in a range between 1 micron and 1 mm.

The predetermined distance d_{gap} at which the antenna 900 is spaced from the hollow waveguide 208 may vary depending upon the carrier frequency of the RF signal being transmitted by the antenna 900. In some embodiments, the predetermined distance d_{gap} at which the antenna 900 is spaced from the hollow waveguide 208 is in a range between 3 μm and 3 mm. In one embodiment, the predetermined distance d_{gap} at which the antenna 900 is spaced from the hollow waveguide 208 is 1 mm. In some embodiments, the antenna 900 may be directly connected to the fifth hollow waveguide 208e.

Referring now to FIG. 9B, shown therein is a top plan view of another exemplary embodiment of the antenna 900 coupled with the fifth hollow waveguide 208e constructed in accordance with the present disclosure. The antenna 900 is similar in construction and function as the antenna 900, with the exception that the antenna 900 includes a first radiator 908a formed of a conductive material having a plurality of coplanar windings. In one embodiment, the first radiator 908a is in the form of a spiral. The first radiator 908a may be wound in a predetermined direction, such as clockwise (i.e., a left-hand wind) or counter-clockwise (i.e., a right-hand wind). While the first radiator 908a of the antenna 900 is depicted in FIG. 9B as having a right-hand wind or a counter-clockwise rotational direction, it should be understood that the first radiator 908a of the antenna 900 may be provided with a left-hand wind or a clockwise rotational direction.

Other embodiments of the antenna 900 include embodiment as a gain horn antenna, a Cassegrain antenna, an omnidirectional antenna, a horn lens antenna, a spot focus antenna, a waveguide probe antenna, a scalar feed horn antenna, a wide-angle scalar feed horn antenna, a trihedral antenna, and a conical horn antenna.

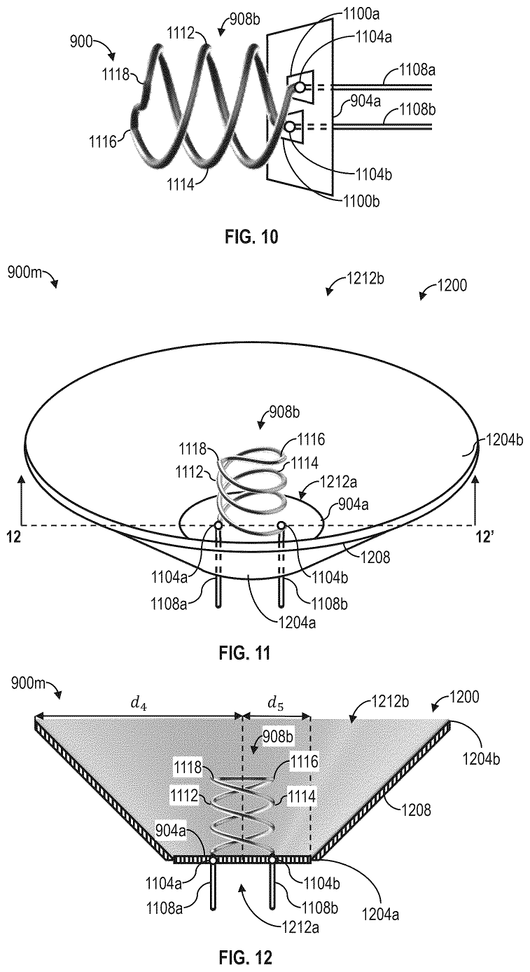

Referring now to FIG. 10, shown therein is another exemplary embodiment of the antenna 900. As shown in FIG. 10, the antenna 900 may be implemented as a bifilar helix antenna. The bifilar helix antenna 900 generally comprises a ground plane 904a having a first differential pad 1100a and a second differential pad 1100b and a second radiator 908b mounted on the ground plane 904a. In some embodiments, the bifilar helix antenna 900 may lack the ground plane 904a. The second radiator 908b is generally in the shape of a double helix and may have a first feed point 1104a electrically connected to the first differential pad 1100a and a second feed point 1104b electrically connected to the second differential pad 1100b. A first coaxial feedline 1108a and a second coaxial feedline 1108b may be electrically connected to the first differential pad 1100a and the second differential pad 1100b, respectively.

In some embodiments, the second radiator 908b may be configured to transmit and detect differential radiated signals. That is, in the transmit direction, the second radiator 908b may receive a first complementary antenna feed signal from the first feed point 1104a and a second complementary antenna feed signal from the second feed point 1104b and transmit the radiated signals based on the first complementary antenna feed signal and the second complementary antenna feed signal. Further, in the receive direction, the second radiator 908b may receive the radiated signals and provide the first complementary antenna output signal to the first feed point 1104a and the second complementary antenna output signal to the second feed point 1104b. In such embodiments, the first complementary antenna output signal and the second complementary antenna output signal may be equal in magnitude but opposite in phase (i.e., out of phase by) 180°.

The second radiator 908b may be wound in a predetermined direction, such as clockwise or counter-clockwise. While the second radiator 908b of the bifilar helix antenna 900 is depicted in FIG. 9 as having a left-hand wind or a clockwise rotational direction, it should be understood that the second radiator 908b of the bifilar helix antenna 900 may be provided with a right-hand wind or a counter-clockwise rotational direction.

The second radiator 908b may comprise a first radiator portion 1112 and a second radiator portion 1114. The first radiator portion 1112 has a first end formed by the first feed point 1104a and a second end 1116 spaced a distance from the first feed point 1104a. The first radiator portion 1112 is in the form of a spiral (i.e., a helix shape). The second radiator portion 1114 has a third end formed by the second feed point 1104b and a fourth end 1118 spaced a distance from the second feed point 1104b. The second radiator portion 1114 is in the form of a spiral (i.e., a helix shape). The second end 1116 of the first radiator portion 1112 is connected to the fourth end 1118 of the second radiator portion 1114.

Referring now to FIGS. 11 and 12, shown therein is another exemplary embodiment of the bifilar helix antenna 900 shown in FIG. 10. As shown in FIGS. 11 and 12, in some embodiments, a conductive cone 1200 may be provided surrounding the bifilar helix antenna 900 (i.e., such that the bifilar helix antenna 900 is enclosed within the conductive cone 1200). The second radiator 908b may be wound in a predetermined direction, such as clockwise or counter-clockwise. While the second radiator 908b of the bifilar helix antenna 900 enclosed within the conductive cone 1200 is depicted in FIGS. 11 and 12 as having a left-hand wind or a clockwise rotational direction, it should be understood that the second radiator 908b of the bifilar helix antenna 900 enclosed within the conductive cone 1200 may be provided with a right-hand wind or a counter-clockwise rotational direction.

The conductive cone 1200 may have a first end 1204a, a second end 1204b opposite the first end 1204a, and a sidewall 1208 extending between the first end 1204a and the second end 1204b. The sidewall 1208 may define a first opening 1212a at the first end 1204a and a second opening 1212b at the second end 1204b. As shown in FIGS. 11 and 12, the first end 1204a of the conductive cone 1200 is generally provided with a diameter d₄ shorter than a diameter d₅ of the second end 1204b of the conductive cone 1200.

The bifilar helix antenna 900 enclosed within the conductive cone 1200 may be configured to transmit circularly polarized signals with a relatively high gain (e.g., more than 6 decibels relative to isotropic (dBi), such as 10 dBi, 12 dBi, 14 dBi, 15 dBi, 16 dBi, 18 dBi, or 20 dBi, for example). In the embodiment shown in FIGS. 11 and 12, the bifilar helix antenna 900 enclosed within the conductive cone 1200 may function as an efficient, wide-bandwidth polarizer. That is, the bifilar helix antenna 900 enclosed within the conductive cone 1200 may be configured to transmit circularly polarized RF signals with a high radiation efficiency (e.g., greater than 50%, such as 60%, 70%, 75%, 80%, 85%, 90%, or 95%, for example). Losses in radiation efficiency are generally due to losses in conductors or substrates. Further, the bifilar helix antenna 900 enclosed within the conductive cone 1200 may be configured to transmit circularly polarized signals with a wide bandwidth (e.g., greater than 10% of center frequency, such as 12%, 14%, 15%, 16%, 18%, 20%, 22%, 24%, or 25%, for example).

The diameter of the bifilar helix antenna 900 may be less than the wavelength of the signals transmitted by the bifilar helix antenna 900. In some embodiments, the conductive cone 1200 may be constructed of a conductive material, such as aluminum, copper, silver, gold, other conductive metals, combinations thereof, and/or the like.

It will be understood by persons having ordinary skill in the art that circularly polarized signals transmitted by a radiator 908 of a first particular one of the antennas 900 may be received only by a radiator 908 of a second particular one of the antennas 900 having the same rotational direction. That is, for example, the radiator 908 shown in FIG. 8A and the first radiator 908a shown in FIG. 8B are depicted as having a right-hand wind or a counter-clockwise rotational direction. As a result, circularly polarized RF signals transmitted by the radiator 908 shown in FIG. 9A or the first radiator 908a shown in FIG. 9B would have a right-hand circular polarization (RHCP). On the other hand, the second radiator 908b shown in FIGS. 10-12 is depicted as having a left-hand wind or a clockwise rotational direction. As a result, circularly polarized RF signals transmitted by the second radiator 908b shown in FIGS. 10-12 would have a left-hand circular polarization (LHCP).

Because circularly polarized signals transmitted by a radiator 908 of a first particular one of the antennas 900 may be received only by a radiator 908 of a second particular one of the antennas 900 having the same rotational direction, circularly polarized RF signals transmitted by the radiator 908 as depicted in FIG. 9A or the first radiator 908a as depicted in FIG. 9B (i.e., RHCP RF signals) could not be received by the second radiator 908b as depicted in FIGS. 10-12. Similarly, circularly polarized signals transmitted by the second radiator 908b as depicted in FIGS. 10-12 (i.e., LHCP RF signals) could not be received by the radiator 908 as depicted in FIG. 9A or the first radiator 908a as depicted in FIG. 9B. However, circularly polarized signals transmitted by the radiator 908 as depicted in FIG. 8A (i.e., RHCP RF signals) could be received by the first radiator 908a as depicted in FIG. 9B, and circularly polarized signals transmitted by the second radiator 908b as depicted in FIG. 10 (i.e., LHCP RF signals) could be received by the second radiator 908b as depicted in FIGS. 11 and 12.

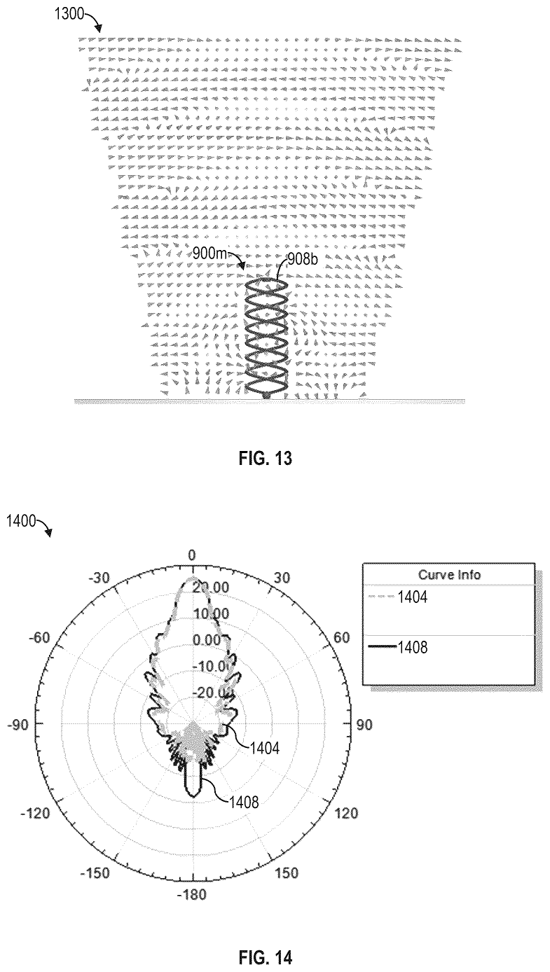

Referring now to FIG. 13, shown therein is a diagrammatic view of an electric field 1300 produced by the bifilar helix antenna 900 enclosed within the conductive cone 1200 shown in FIGS. 11 and 12. As illustrated in FIG. 13, the bifilar helix antenna 900 enclosed within the conductive cone 1200 may be operable to produce the electric field 1300 such that a near-field region of the electric field 1300 and a far-field region of the electric field 1300 are established with a greater directivity than would be provided by conventional antennas. Further, the bifilar helix antenna 900 enclosed within the conductive cone 1200 may be operable to produce the electric field 1300 in a manner that does not interfere with the circular polarization of the circularly polarized radiated signals transmitted by the second radiator 908b.

Referring now to FIG. 14, shown therein is a diagrammatic view of a radiation pattern 1400 of the bifilar helix antenna 900 enclosed within the conductive cone 1200 shown in FIGS. 11 and 12. The radiation pattern 1400 may correspond to a transmission signal having a frequency of 2,000 GHz and a phase of 0°. As shown in FIG. 14, a first curve 1404 demonstrates an LHCP gain of the bifilar helix antenna 900 enclosed within the conductive cone 1200, while a second curve 1408 demonstrates a total directivity of the bifilar helix antenna 900 enclosed within the conductive cone 1200. A difference between the first curve 1404 and the second curve 1408 may indicate metal and polarization losses. As illustrated in FIG. 14 and as described above in relation to FIG. 13, the bifilar helix antenna 900 enclosed within the conductive cone 1200 may be operable to produce the electric field 1300 such that a near-field region 1304 of the electric field 1300 and a far-field region 1308 of the electric field 1300 are established with a greater directivity than would be provided by conventional antennas.

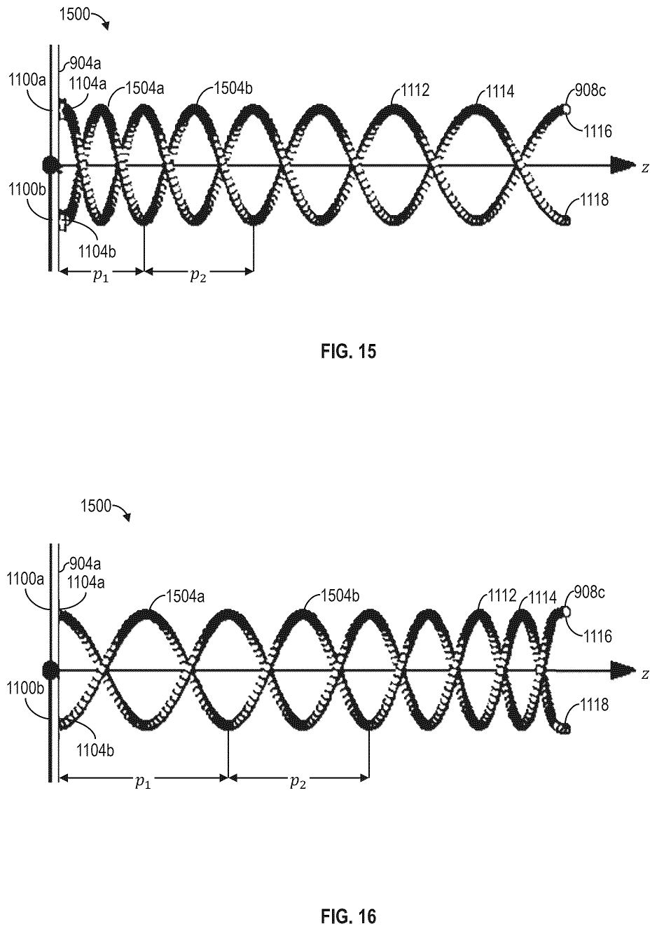

Referring now to FIGS. 15 and 16, shown therein are side views of exemplary embodiments of a non-uniform bifilar helix antenna 1500 (hereinafter, the “non-uniform antenna 1500”) constructed in accordance with the present disclosure. Providing the antenna with a non-uniform design is effective because the size of the helix determines the frequency of operation. By varying characteristic dimensions of the helix, a wider band of frequencies may be effectively radiated.

Similar to the bifilar helix antenna 900 described above, the non-uniform antenna 1500 may comprise the ground plane 904a having the first differential pad 1100a and the second differential pad 1100b and a non-uniform third radiator 908c mounted on the ground plane 904a. The third radiator 908c may have a plurality of turns 1504a-n including at least a first turn 1504a and a second turn 1504b. For purposes of clarity, only the first turn 1504a and the second turn 1504b are labeled with a reference character. The first turn 1504a may have a first characteristic dimension, while the second turn 1504b may have a second characteristic dimension different from the first characteristic dimension. The first turn 1504a may be adjacent to the second turn 1504b or non-adjacent to (i.e., spaced from) the second turn 1504b.

In the embodiment shown in FIG. 15, the first turn 1504a has a first pitch p₁, the second turn 1504b has a second pitch p₂, and the first pitch p₁ is less than the second pitch p₂. the embodiment shown in FIG. 15, the first turn 1504a has the first pitch p₁, the second turn 1504b has the second pitch p₂, and the first pitch p₁ is greater than the second pitch p₂.

In some embodiments, the non-uniform antenna 1500 may lack the ground plane 904a. The third radiator 908c is generally in the shape of a double helix and may have the first feed point 1104a electrically connected to the first differential pad 1100a and the second feed point 1104b electrically connected to the second differential pad 1100b. The first coaxial feedline 1108a and the second coaxial feedline 1108b may be electrically connected to the first differential pad 1100a and the second differential pad 1100b, respectively.

In some embodiments, the third radiator 908c may be configured to emit and receive differential signals. That is, in the transmit direction, the third radiator 908c may receive a first complementary signal from the first feed point 1104a and a second complementary signal from the second feed point 1104b and transmit the transmission signal. Further, in the receive direction, the third radiator 908c may receive the transmission signal and provide the first complementary signal to the first feed point 1104a and the second complementary signal to the second feed point 1104b. In such embodiments, the first complementary signal and the second complementary signal may be equal in magnitude but opposite in phase (i.e., out of phase by) 180°.

The third radiator 908c may be wound in a predetermined direction, such as clockwise or counter-clockwise. While the third radiator 908c of the non-uniform antenna 1500 is depicted in FIGS. 15 and 16 as having a right-hand wind or a counter-clockwise rotational direction, it should be understood that the third radiator 908c of the non-uniform antenna 1500 may be provided with a left-hand wind or a clockwise rotational direction.

The third radiator 908c may comprise the first radiator portion 1112 and the second radiator portion 1114. The first radiator portion 1112 has the first end formed by the first feed point 1104a and the second end 1116 spaced a distance from the first feed point 1104a. The first radiator portion 1112 is in the form of a spiral (i.e., a helix shape). The second radiator portion 1114 has the third end formed by the second feed point 1104b and the fourth end 1118 spaced a distance from the second feed point 1104b. The second radiator portion 1114 is in the form of a spiral (i.e., a helix shape). While the second end 1116 and the fourth end 1118 are shown as being disconnected from each other, it should be understood that, in some embodiments, the second end 1116 of the first radiator portion 1112 is connected to the fourth end 1118 of the second radiator portion 1114.

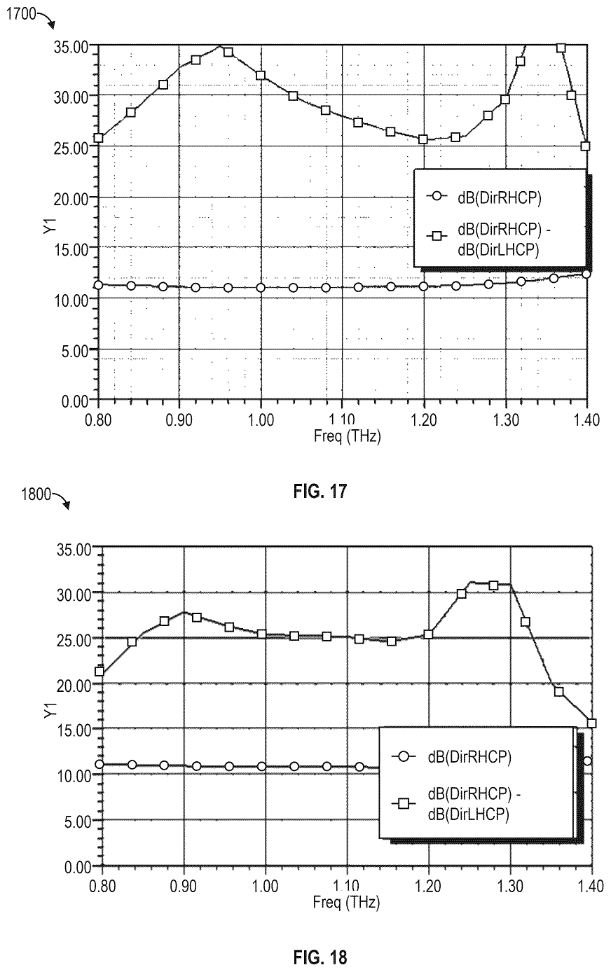

The non-uniform antenna 1500 provides a wider frequency response in comparison to uniform antennas existing in the prior art and the uniform bifilar helix antennas discussed herein. A mathematical equation for the helical shape of the non-uniform radiator 908c of the non-uniform antenna 1500 in three-dimensional space is shown in Table 1 below and in a graph 1700 shown in FIG. 17, while the polarization discrimination of a uniform antenna across the frequency range between 0.80 THz and 1.40 THz is shown in a graph 1800 shown in FIG. 18. As shown in FIGS. 17 and 18, the polarization discrimination may be determined by subtracting the left-hand circular polarization directivity (i.e., DirLHCP) from the right-hand circular polarization directivity (i.e., DirRHCP). As shown in Table 1 and FIG. 16, the right-hand circular polarization directivity (i.e., DirRHCP) of the non-uniform antenna 1500 may be relatively constant (i.e., 11.5 dBi±1 dBi) in the frequency range between 0.80 THz and 1.40 THz. Furthermore, as shown in FIG. 17, the polarization discrimination (i.e., DirRHCP-DirLHCP) of the non-uniform antenna 1500 remains above 25 dB across the frequency range between 0.80 THz and 1.40 THz. Conversely, as shown in FIG. 18, the polarization discrimination (i.e., DirRHCP-DirLHCP) of a uniform antenna dips below 25 dB at the band edges and slightly below 25 dB in the midband range.

TABLE 1
Mathematical Equation for a Helical Shape of
the Non-Uniform Radiator 908c of the Non-Uniform
Antenna 1500 in Three-Dimensional Space

| X(t) | 41 * cos(t) [μm] |
|---|---|
| Y(t) | 41 * sin(t) [μm] |
| Z(t) | 0.293 * t * |
| | (t + 25) [μm] |
| start(t) | 0 |
| end(t) | 25.13 |

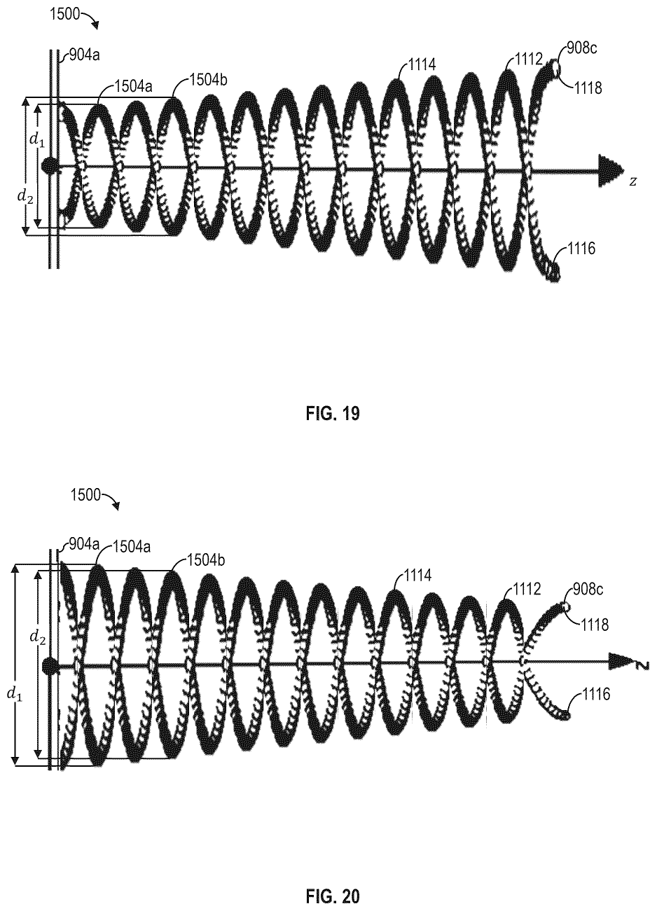

Referring now to FIGS. 18 and 20, shown therein are side views of more exemplary embodiments of the non-uniform antenna 1500 shown in FIGS. 15 and 16. For purposes of clarity, the differential pads 1100 and the feed points 1104 are not labeled with a reference character in FIGS. 18 and 19. In the embodiments shown in FIGS. 19 and 20, the first characteristic dimension and the second characteristic dimension are not pitches, but diameters. In the embodiment shown in FIG. 19, the first turn 1504a has a first diameter d₁, the second turn 1504b has a second diameter d₂, and the first diameter d₁ is less than the second diameter d₂. In the embodiment shown in FIG. 20, the first turn 1504a has the first diameter d₁, the second turn 1504b has the second diameter d₂, and the first diameter d₁ is greater than the second diameter d₂.

Varying the diameters d₁₋ₙ of the turns 1504 of the third radiator 908c rather than the pitches p₁₋ₙ of the turns 1504 of the third radiator 908c may be advantageous in different bands or with different ground plane dimensions, wire dimensions, etc.

It should be understood that the third radiator 908c and/or the non-uniform antenna 1500 may be included in place of any of the respective radiators 908 and/or antennas 900 described herein. Further, it should be understood that, while the second turn 1504b is shown as being directly adjacent to the first turn 1504a, there may be one or more turns in between the first turn 1504a and the second turn 1504b. Finally, it should be understood that, while the first turn 1504a is shown as being directly adjacent to the ground plane 904a, there may be one or more turns in between the ground plane 904a and the first turn 1504a.

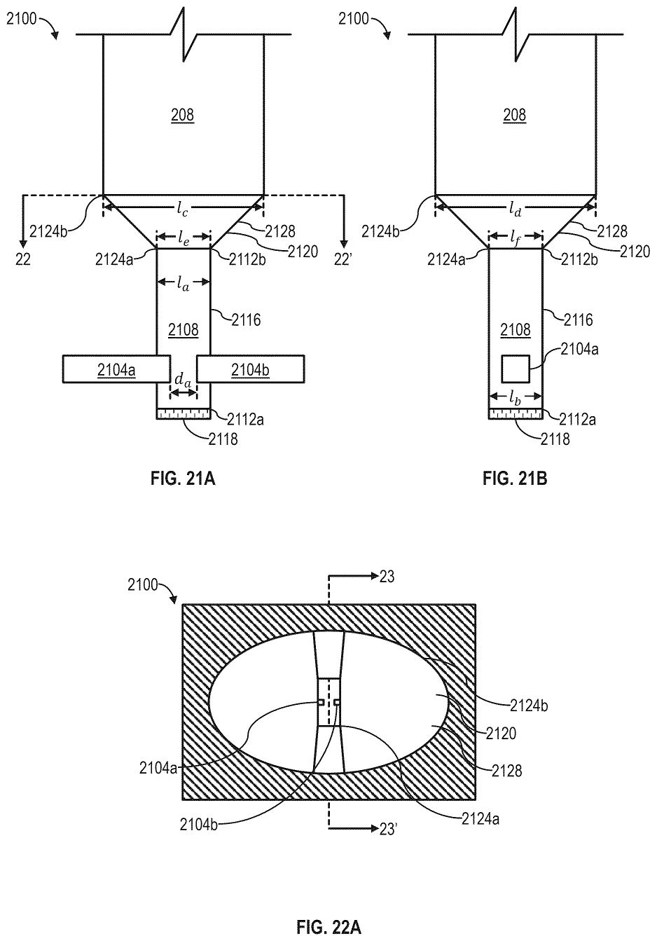

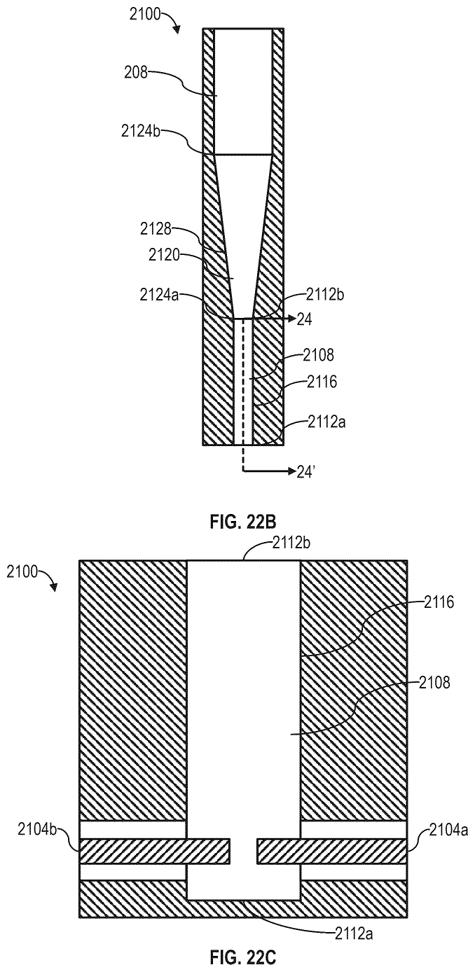

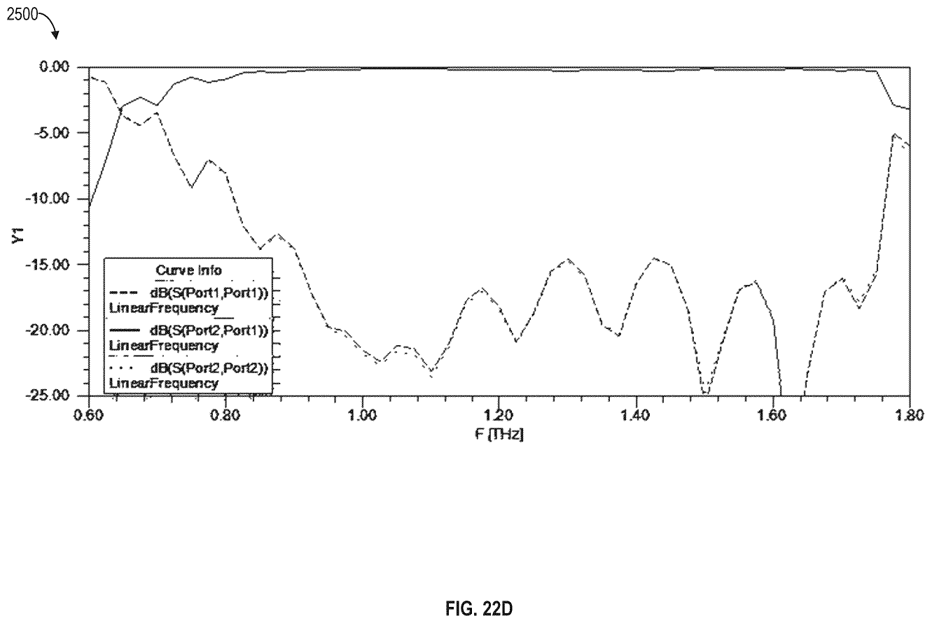

Referring now to FIGS. 21A, 21B, and 22A-22C, shown therein is a differential waveguide probe antenna 2100 constructed in accordance with the present disclosure. The differential waveguide probe antenna 2100 is configured to generate and transmit the transmission signal. Conversely, the differential waveguide probe antenna 2100 is further configured to receive the transmission signal. The differential waveguide probe antenna 2100 comprises a pair of waveguide probes 2104 including a first waveguide probe 2104a and a second waveguide probe 2104b.

In some embodiments, the differential waveguide probe antenna 2100 may further comprise an intermediary waveguide 2108 configured to propagate the transmission signal. In such embodiments, the differential waveguide probe antenna 2100 may be further configured to generate and transmit the transmission signal into the intermediary waveguide 2108. Conversely, in such embodiments, the differential waveguide probe antenna 2100 may be further configured to receive the transmission signal from the intermediary waveguide 2108.

The intermediary waveguide 2108 may have a first end 2112a, a second end 2112b (the first end 2112a and the second end 2112b, collectively, the “ends 2112”) opposite the first end 2112a, and a surface 2116 extending between the ends 2112. In some embodiments, a back reflector 2118 may abut the first end 2112a. The surface 2116 may be constructed of a metal. The intermediary waveguide 2108 may be constructed as such in order to ensure that one or more intended waveguide modes are established. That is, were the intermediary waveguide 2108 to be constructed at a smaller size, the one or more intended waveguide modes may not be able to propagate, and were the intermediary waveguide 2108 to be constructed at a larger size, one or more unintended waveguide modes may be excited. In some embodiments, the one or more intended waveguide modes of the intermediary waveguide 2108 sufficiently matches the one or more intended waveguide modes of the hollow waveguide 208 such that a coupling loss between the intermediary waveguide 2108 and the hollow waveguide 208 is minimized (e.g., the coupling loss is in a range between 0.1 dB and 5.0 dB).

As shown in FIG. 21A, in a first direction, the intermediary waveguide 2108 may have a first cross-sectional length lₐ greater than zero and less than two wavelengths of the transmission signal at 10 THz (or a maximum frequency in the frequency band occupied by the transport network 200) (i.e., 60 μm). Further, as shown in FIG. 21B, in a second direction perpendicular to the first direction, the intermediary waveguide 2108 may have a second cross-sectional length l_{b} less than two wavelengths of the transmission signal at 10 THz (or a maximum frequency in the frequency band occupied by the transport network 200) (i.e., 60 μm) and greater than one-half wavelength at 300 GHz (or a minimum frequency in the frequency band occupied by the transport network 200) (i.e., 0.5 mm).

The waveguide probes 2104 may be positioned on opposite sides of the surface 2116 of the intermediary waveguide 2108 and may extend into the intermediary waveguide 2108 toward each other, but may be spaced a first distance dₐ from each other. The waveguide probes 2104 may thus establish a strong electrical field in line with the one or more intended waveguide modes. Each of the waveguide probes 2104 may be excited with the transmission signal. In some embodiments, each of the waveguide probes 2104 may be excited with the transmission signal at an equal strength and/or an opposite phase. That is, the waveguide probes 2104 may be configured to receive the transmission signal as a differential signal having a first complementary signal and a second complementary signal and generate and transmit the transmission signal in the electromagnetic wave form. Conversely, the waveguide probes 2104 may be further configured to receive the transmission signal and provide the transmission signal as a differential signal having a first complementary signal and a second complementary signal.

In some embodiments, the intermediary waveguide 2108 may have a flared end at the second end 2112b configured to facilitate a mode transition between the intermediary waveguide 2108 and the hollow waveguide 208. In such embodiments, as shown in FIG. 21A, in the first direction, the intermediary waveguide 2108 at the flared end may have a third cross-sectional length l_{c} greater than the first cross-sectional length lₐ. Further, as shown in FIG. 21B, in the second direction perpendicular to the first direction, the intermediary waveguide 2108 at the flared end may have a fourth cross-sectional length l_{d} greater than the second cross-sectional length l_{b}. In some such embodiments, the flared end may be formed integrally with the intermediary waveguide 2108. However, in other such embodiments, the flared end may be constructed as a horn 2120 separate from but coupled to the intermediary waveguide 2108. The horn 2120 may have a first end 2124a abutting the second end 2112b of the intermediary waveguide 2108, a second end 2124b (the first end 2124a and the second end 2124b, collectively, the “ends 2124”) opposite the first end 2124a, and a curved surface 2128 extending between the ends 2124.

As shown in FIG. 21A, in the first direction, the horn 2120 at the first end 2124a may have a fifth cross-sectional length lₑ equal to the first cross-sectional length lₐ. Further, as shown in FIG. 21B, in the second direction perpendicular to the first direction, the horn 2120 at the first end 2124a may have a sixth cross-sectional length l_{f} equal to the second cross-sectional length l_{b}.

The differential waveguide probe antenna 2100 may be configured to transmit the transmission signal with a wide (i.e., greater than 50%) bandwidth into the hollow waveguide 208 at least in part because an energy contribution from each of the waveguide probes 2104 effectively cancels out the higher-order, unintended waveguide modes of the other waveguide probe 2104. A polarization discrimination of the differential waveguide probe antenna 2100 across a frequency range between 0.60 THz and 1.80 THz is shown in a graph 2500 shown in FIG. 22D.

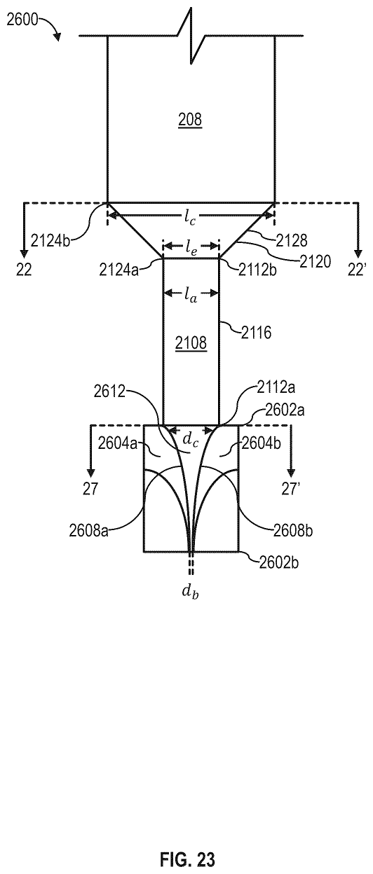

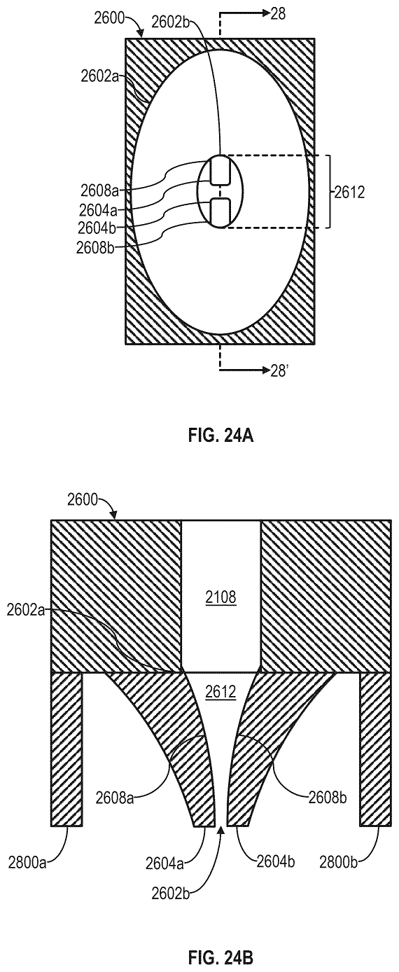

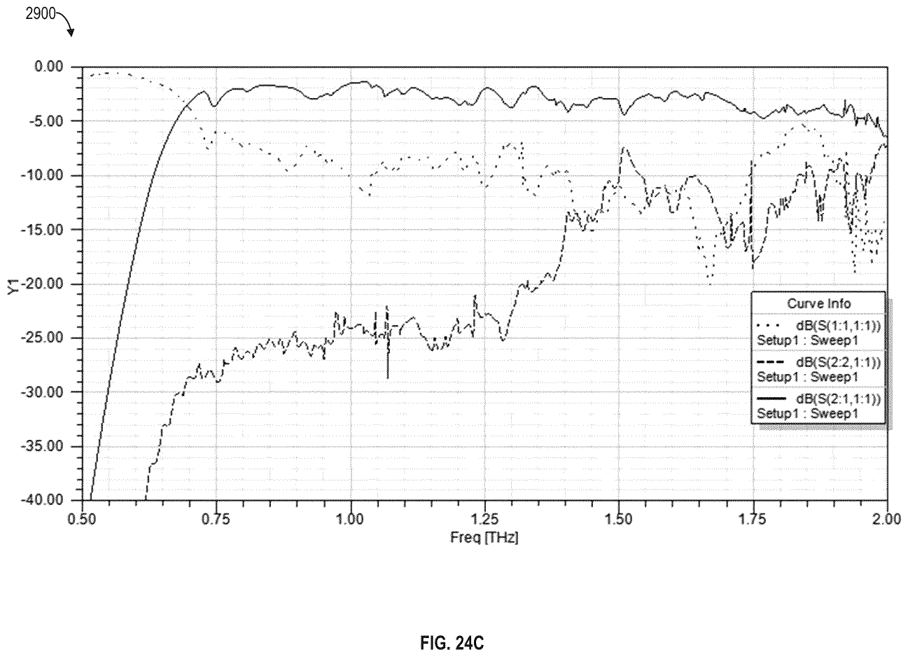

Referring now to FIGS. 23, 24A, and 24B, shown therein is an exemplary embodiment of a differential tapered antenna 2600 constructed in accordance with the present disclosure. The differential tapered antenna 2600 is configured to generate and transmit the transmission signal in the electromagnetic wave form—and, conversely, receive the transmission signal in the electromagnetic wave form. The differential tapered antenna 2600 may have a first end 2602a and a second end 2602b (the first end 2602a and the second end 2602b, collectively, the “ends 2602”) opposite the first end 2602a and may comprise a pair of conductors including a first conductor 2604a and a second conductor 2604b (collectively, the “conductors 2604”) spaced a second distance d_{b} from the first conductor 2604a at the second end 2602b and a third distance d_{c} at the first end 2602a.

The differential tapered antenna 2600 may be similar in some respects to a tapered slot antenna and in some respects to a ridged horn antenna. However, the differential tapered antenna 2600 differs from such antennas due to the differential tapered antenna 2600 having a differential launch and being coupled into the intermediary waveguide 2018 which is sized and dimensioned such that the intermediary waveguide 2018 may propagate multiple waveguide modes simultaneously. However, it should be understood that, in some embodiments, the differential tapered antenna 2600 may be configured to excite only a single waveguide mode at a given time.

The differential tapered antenna 2600 may be configured to generate and transmit the transmission signal into the intermediary waveguide 2108 and receive the transmission signal from the intermediary waveguide 2108. In some embodiments, the differential tapered antenna 2600 may be configured to couple the transmission signal directly into—and receive the transmission signal directly from—the hollow waveguide 208, rather than the intermediary waveguide 2108.

In the embodiment shown in FIGS. 23, 24A, and 24B, the differential tapered antenna 2600 has a first planar, yet longitudinally directed curved surface 2608a and a second planar, yet longitudinally directed curved surface 2608b (collectively, the “curved surfaces 2608”) bordering a space 2612. In some embodiments, the second distance d_{b} between the first conductor 2604a and the second conductor 2604b at the second end 2602b is greater than zero and less than two wavelengths of the transmission signal at 10 THz (or the maximum frequency in the frequency band occupied by the transport network 200). The second distance d_{b} may be selected to establish a single waveguide mode for the frequency of the transmission signal. In some embodiments, a third distance d_{c} between the conductors 2604 at the first end 2602a is greater than the second distance d_{b}. This tapered shape may establish a continuously scaled geometry which enables an ultra-wide (i.e., greater than 50%) bandwidth. As energy launches down the conductors 2604, the one or more intended waveguide modes are established between the conductors 2604 and subsequently launched into the intermediary waveguide 2108.

In some embodiments, each of the conductors 2604 may be fed with the transmission signal at an equal strength and/or an opposite phase. That is, the conductors 2604 may be configured to receive the transmission signal as a differential signal having a first complementary signal and a second complementary signal and generate and transmit the transmission signal in the electromagnetic wave form. Conversely, the conductors 2604 may be further configured to receive the transmission signal and provide the transmission signal as a differential signal having a first complementary signal and a second complementary signal.

A thickness and a width of the transmission lines at the feed point may be selected to establish a characteristic impedance matched to the receiver and/or driver. Persons having ordinary skill in the art will understand how to perform such calculations. As shown in FIG. 24B, the differential tapered antenna 2600 may further comprise one or more ground connections, such as a first ground connection 2800a and a second ground connection 2800b. A polarization discrimination of the differential tapered antenna 2600 across a frequency range between 0.50 THz and 2.00 THz is shown in a graph 2900 shown in FIG. 24C.

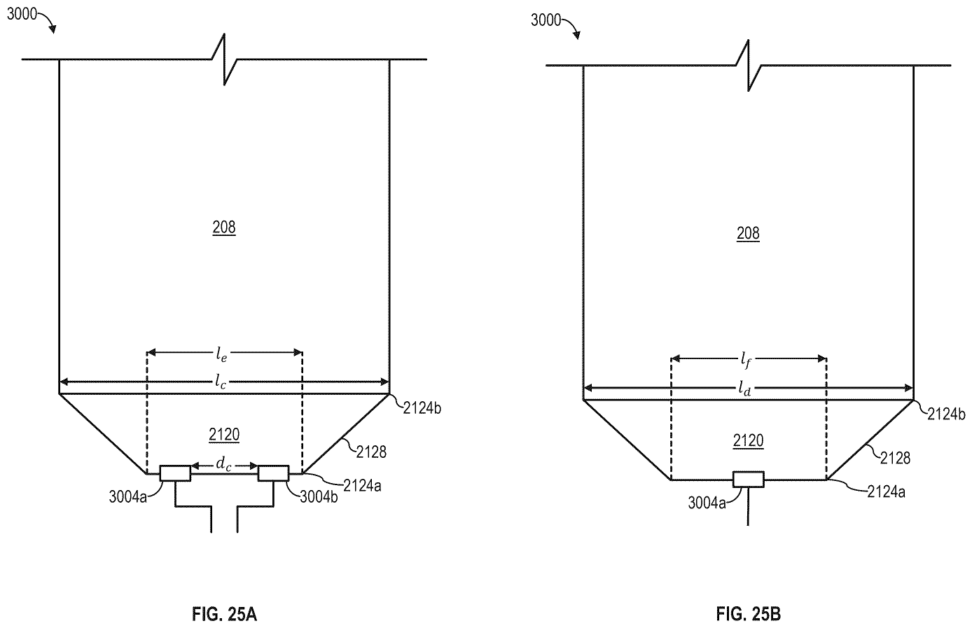

Referring now to FIGS. 25A and 25B, shown therein is an exemplary embodiment of a microstrip patch antenna array 3000 constructed in accordance with the present disclosure. The microstrip patch antenna array 3000 is configured to generate and transmit the transmission signal in the electromagnetic wave form and, conversely, receive the transmission signal in the electromagnetic wave form.

In some embodiments, the microstrip patch antenna array 3000 comprises a pair of microstrip patch antennas 3004 including a first microstrip patch antenna 3004a and a second microstrip patch antenna 3004b (collectively, the “microstrip patch antennas 3004”) spaced a third distance d_{c} from the first microstrip patch antenna 3004a. However, in other embodiments, the microstrip patch antenna array 3000 may comprise more than two of the microstrip patch antennas 3004.

In some embodiments, the microstrip patch antenna array 3000 may further comprise the horn 2120 having the first end 2124a proximal to the microstrip patch antennas 3004, the second end 2124b distal to the microstrip patch antennas 3004, and the curved surface 2128 extending between the ends 2124. As shown in FIG. 25A, in a first direction, the horn 2120 at the first end 2124a may have the fifth cross-sectional length lₑ, and the horn 2120 at the second end 2124b may have the third cross-sectional length l_{c} greater than the fifth cross-sectional length lₑ. Further, as shown in FIG. 25B, in a second direction perpendicular to the first direction, the horn 2120 at the first end 2124a may have the sixth cross-sectional length l_{f}, and the horn 2120 at the second end 2124b may have the fourth cross-sectional length l_{d} greater than the sixth cross-sectional length l_{f}.

In some embodiments, each of the microstrip patch antennas 3004 may be fed with the transmission signal at an equal strength and/or an opposite phase. However, in other embodiments, each of the microstrip patch antennas 3004 may be fed with the transmission signal at an equal strength and/or an equal phase. That is, the microstrip patch antennas 3004 may be configured to receive the transmission signal as a differential signal having a first complementary signal and a second complementary signal and generate and transmit the transmission signal in the electromagnetic wave form. Conversely, the microstrip patch antennas 3004 may be further configured to receive the transmission signal and provide the transmission signal as a differential signal having a first complementary signal and a second complementary signal.

The differential waveguide probe antenna 2100, the differential tapered antenna 2600, and the microstrip patch antenna array 3000 are configured to generate the transmission signal in a linearly polarized form.

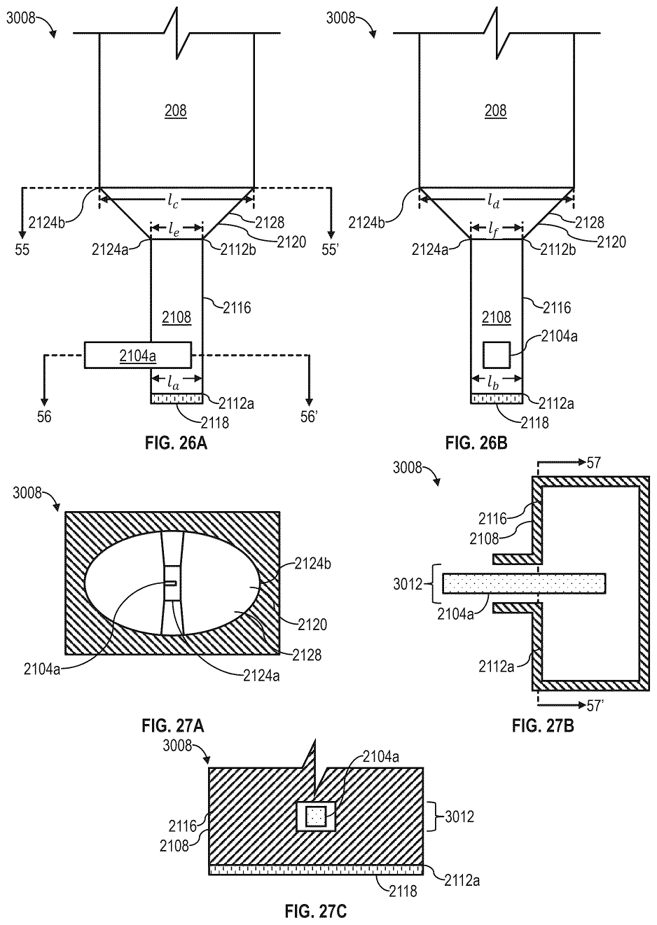

Referring now to FIGS. 26A, 26B, and 27A-27C, shown therein is a diagrammatic view of an exemplary embodiment of a single-ended waveguide probe antenna 3008 constructed in accordance with the present disclosure. In some embodiments, the single-ended waveguide probe antenna 3008 may lack the second waveguide probe 2104b, thereby only comprising the first waveguide probe 2104a. Further, in some embodiments, the surface 2116 of the intermediary waveguide 2108 may define an opening 3012 through which the first waveguide probe 2104a extends. As referenced above, in some embodiments, the first end 2112a of the intermediary waveguide 2108 may serve as a back reflector.

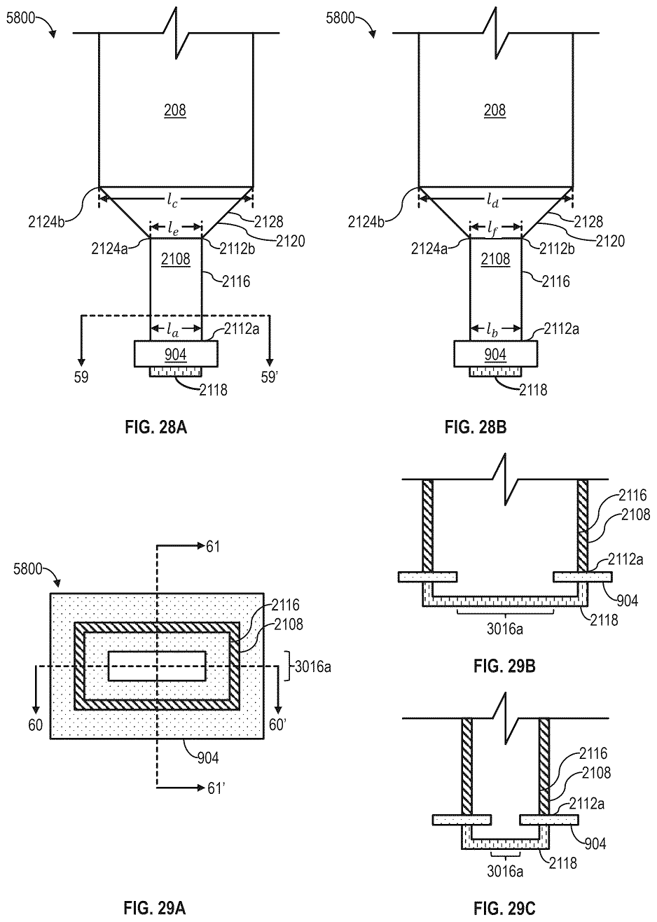

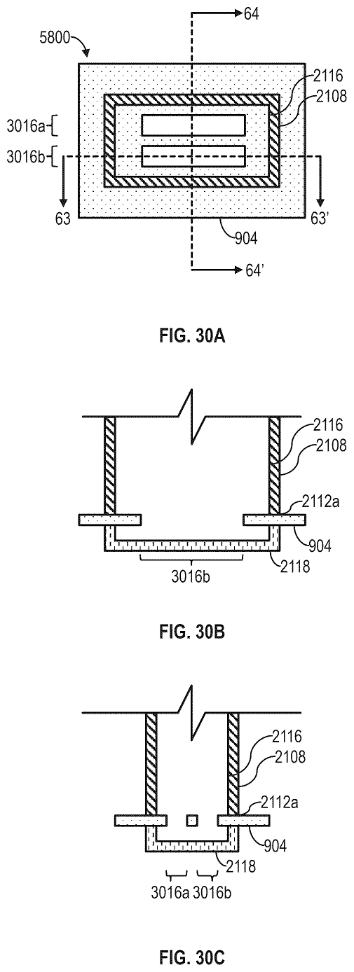

Referring now to FIGS. 28A, 28B, 29A-29C, and 30A-30C, shown therein are diagrammatic views of exemplary embodiments of a slot antenna 5800 constructed in accordance with the present disclosure. As shown in FIGS. 28A, 28B, 29A-29C, and 30A-30C, the slot antenna 5800 may include the ground plane 904 disposed between the intermediary waveguide 2108 and the back reflectors 2118. In some embodiments, the ground plane 904 may define one or more slots 3016 (e.g., a first slot 3016a shown in FIGS. 29A-C, 30A, and 30C and a second slot 3016b shown in FIGS. 30A-30C) (hereinafter, the “slots 3016”).

Any of the antennas disclosed herein can be used in combination with network elements described above that communicate using radio frequency communications transmitted and received by antennas. The radio frequency (RF) communications have a carrier frequency in what is referred to as a Terahertz (THz) frequency band 104 (i.e., frequencies between 0.1 THz and 10 THz and wavelengths between 3 millimeters (mm) and 30 micrometers (μm)). Where certain aspects of the present disclosure are described as relating to “THz”, it should be understood that such aspects of the present disclosure relate to the THz frequency band 104.

### ILLUSTRATIVE CLAUSES

Exemplary, non-limiting illustrative embodiments of the present disclosure are provided in the clauses below. However, the scope of the present inventive concept(s) is to be understood to not be limited in any manner by the clauses presented below.

Illustrative clause 1. A transmitter, comprising: a client-side input configured to receive one or more baseband signals having client data encoded therein; transmitter circuitry configured to receive the one or more baseband signals from the client-side input and generate one or more antenna feed signals based on the one or more baseband signals; and one or more antennas configured to receive the one or more antenna feed signals from the transmitter circuitry, generate one or more radiated signals based on the one or more antenna feed signals, and couple the one or more radiated signals into one or more hollow waveguides, the one or more radiated signals being radiated electromagnetic waves configured for coherent detection and having one or more frequencies in a range between 300 Gigahertz (GHz) and 10 Terahertz (THz); wherein the one or more antennas include a helical antenna.

Illustrative clause 2. The transmitter of illustrative clause 1, wherein the helical antenna is a bifilar helical antenna having a pair of wires.

Illustrative clause 3. The transmitter of illustrative clause 2, wherein each particular wire of the pair of wires of the helical antenna has a plurality of coils including a first coil and a second coil, the first coil of each particular wire having a first characteristic dimension, the second coil of each particular wire having a second characteristic dimension different from the first characteristic dimension of the particular wire.

Illustrative clause 4. The transmitter of illustrative clause 3, wherein the plurality of coils of each particular wire further includes a third coil, the first coil of each particular wire is adjacent to the second coil of the particular wire, and the second coil of each particular wire is adjacent to the third coil of the particular wire, the first characteristic dimension of the first coil of each particular wire being a first pitch measured between the first coil of the particular wire and the second coil of the particular wire, the second characteristic dimension of the second coil of each particular wire being a second pitch measured between the second coil of the particular wire and the third coil of the particular wire.

Illustrative clause 5. The transmitter of illustrative clause 3, wherein the first characteristic dimension of the first coil of each particular wire is a first diameter of the first coil of the particular wire and the second characteristic dimension of the second coil of each particular wire is a second diameter of the second coil of the particular wire.

Illustrative clause 6. The transmitter of illustrative clause 1, wherein the helical antenna has a plurality of coils including a first coil and a second coil, the first coil of the helical antenna having a first characteristic dimension, the second coil of the helical antenna having a second characteristic dimension different from the first characteristic dimension.

Illustrative clause 7. The transmitter of illustrative clause 6, wherein the plurality of coils of the helical antenna further includes a third coil, the first coil of the helical antenna is adjacent to the second coil of the helical antenna, and the second coil of the helical antenna is adjacent to the third coil of the helical antenna, the first characteristic dimension of the first coil of the helical antenna being a first pitch measured between the first coil of the helical antenna and the second coil of the helical antenna, the second characteristic dimension of the second coil of the helical antenna being a second pitch measured between the second coil of the helical antenna and the third coil of the helical antenna.

Illustrative clause 8. The transmitter of illustrative clause 6, wherein the first characteristic dimension of the first coil of the helical antenna is a first diameter of the first coil of the helical antenna and the second characteristic dimension of the second coil of the helical antenna is a second diameter of the second coil of the helical antenna.

Illustrative clause 9. The transmitter of illustrative clause 1, wherein the helical antenna of the one or more antennas has a conductive cone surrounding the helical antenna.

Illustrative clause 10. A transmitter, comprising: a client-side input configured to receive one or more baseband signals having client data encoded therein; transmitter circuitry configured to receive the one or more baseband signals from the client-side input and generate one or more antenna feed signals based on the one or more baseband signals; and one or more antennas configured to receive the one or more antenna feed signals from the transmitter circuitry, generate one or more radiated signals based on the one or more antenna feed signals, and couple the one or more radiated signals into one or more hollow waveguides, the one or more radiated signals being radiated electromagnetic waves configured for coherent detection and having one or more frequencies in a range between 300 Gigahertz (GHz) and 10 Terahertz (THz); wherein the one or more antennas include a waveguide probe antenna.

Illustrative clause 11. The transmitter of illustrative clause 10, wherein the waveguide probe antenna is a differential waveguide probe antenna having a pair of waveguide probes.

Illustrative clause 12. The transmitter of illustrative clause 11, wherein the pair of waveguide probes of the waveguide probe antenna includes a first waveguide probe and a second waveguide probe configured to be positioned on opposite sides of a particular hollow waveguide of the one or more hollow waveguides.

Illustrative clause 13. The transmitter of illustrative clause 11, further comprising one or more intermediary waveguides, the one or more antennas being configured to couple the one or more radiated signals into the one or more intermediary waveguides, the one or more intermediary waveguides being configured to receive the one or more radiated signals from the one or more antennas and couple the one or more radiated signals into the one or more hollow waveguides.

Illustrative clause 14. The transmitter of illustrative clause 13, wherein the waveguide probe antenna is a differential waveguide probe antenna having a pair of waveguide probes.

Illustrative clause 15. The transmitter of illustrative clause 14, wherein the pair of waveguide probes of the waveguide probe antenna includes a first waveguide probe and a second waveguide probe configured to be positioned on opposite sides of a particular intermediary waveguide of the one or more intermediary waveguides.

Illustrative clause 16. The transmitter of illustrative clause 13, wherein each particular intermediary waveguide of the one or more intermediary waveguides has a cross-sectional length greater than half of a maximum wavelength corresponding to a minimum frequency of the one or more frequencies of the one or more radiated signals and less than two of a minimum wavelength corresponding to a maximum frequency of the one or more frequencies of the one or more radiated signals.

Illustrative clause 17. The transmitter of illustrative clause 16, wherein the cross-sectional length of each particular intermediary waveguide is a first cross-sectional length of the particular intermediary waveguide, each particular intermediary waveguide further having a first end, a second end, and a second cross-sectional length, and being configured to receive one or more particular radiated signals of the one or more radiated signals from a particular antenna of the one or more antennas into the first end and couple the one or more particular radiated signals into a particular hollow waveguide of the one or more hollow waveguides from the second end, each particular intermediary waveguide further having a flared end at the second end, the flared end of each particular intermediary waveguide having a second cross-sectional length greater than the first cross-sectional length.

Illustrative clause 18. The transmitter of illustrative clause 17, further comprising one or more horns, the one or more intermediary waveguides being configured to couple the one or more radiated signals into the one or more horns, the one or more horns being configured to receive the one or more radiated signals from the one or more intermediary waveguides and couple the one or more radiated signals into the one or more hollow waveguides.

Illustrative clause 19. The transmitter of illustrative clause 18, wherein each particular horn of the one or more horns has a third end, a fourth end, a third cross-sectional length at the third end, and a fourth cross-sectional length greater than the third cross-sectional length at the fourth end, and is configured to receive one or more particular radiated signals of the one or more radiated signals from a particular intermediary waveguide of the one or more intermediary waveguides into the third end and couple the one or more particular radiated signals into a particular hollow waveguide of the one or more hollow waveguides from the fourth end.

Illustrative clause 20. The transmitter of illustrative clause 19, wherein the third cross-sectional length of each particular horn is equal to the second cross-sectional length of the particular intermediary waveguide configured to couple the one or more particular radiated signals into the particular horn.

Illustrative clause 21. The transmitter of illustrative clause 19, wherein each particular horn is configured to couple the one or more particular radiated signals into a particular hollow waveguide having a fifth cross-sectional length equal to the fourth cross-sectional length of the particular horn.

Illustrative clause 22. A transmitter, comprising: a client-side input configured to receive one or more baseband signals having client data encoded therein; transmitter circuitry configured to receive the one or more baseband signals from the client-side input and generate one or more antenna feed signals based on the one or more baseband signals; and one or more antennas configured to receive the one or more antenna feed signals from the transmitter circuitry, generate one or more radiated signals based on the one or more antenna feed signals, and couple the one or more radiated signals into one or more hollow waveguides, the one or more radiated signals being radiated electromagnetic waves configured for coherent detection and having one or more frequencies in a range between 300 Gigahertz (GHz) and 10 Terahertz (THz); wherein the one or more antennas include a tapered antenna.

Illustrative clause 23. The transmitter of illustrative clause 22, further comprising one or more intermediary waveguides, the one or more antennas being configured to couple the one or more radiated signals into the one or more intermediary waveguides, the one or more intermediary waveguides being configured to receive the one or more radiated signals from the one or more antennas and couple the one or more radiated signals into the one or more hollow waveguides.

Illustrative clause 24. The transmitter of illustrative clause 23, wherein the tapered antenna is a differential tapered antenna having a pair of conductors.

Illustrative clause 25. The transmitter of illustrative clause 24, wherein the pair of conductors of the tapered antenna includes a first conductor and a second conductor configured to be positioned on opposite sides of a particular intermediary waveguide of the one or more intermediary waveguides.

Illustrative clause 26. The transmitter of illustrative clause 23, wherein each particular intermediary waveguide of the one or more intermediary waveguides has a cross-sectional length greater than half of a maximum wavelength corresponding to a minimum frequency of the one or more frequencies of the one or more radiated signals and less than two of a minimum wavelength corresponding to a maximum frequency of the one or more frequencies of the one or more radiated signals.

Illustrative clause 27. The transmitter of illustrative clause 26, wherein the cross-sectional length of each particular intermediary waveguide is a first cross-sectional length of the particular intermediary waveguide, each particular intermediary waveguide further having a first end, a second end, and a second cross-sectional length, and being configured to receive one or more particular radiated signals of the one or more radiated signals from a particular antenna of the one or more antennas into the first end and couple the one or more particular radiated signals into a particular hollow waveguide of the one or more hollow waveguides from the second end, each particular intermediary waveguide further having a flared end at the second end, the flared end of each particular intermediary waveguide having a second cross-sectional length greater than the first cross-sectional length.

Illustrative clause 28. The transmitter of illustrative clause 27, further comprising one or more horns, the one or more intermediary waveguides being configured to couple the one or more radiated signals into the one or more horns, the one or more horns being configured to receive the one or more radiated signals from the one or more intermediary waveguides and couple the one or more radiated signals into the one or more hollow waveguides.

Illustrative clause 29. The transmitter of illustrative clause 28, wherein each particular horn of the one or more horns has a third end, a fourth end, a third cross-sectional length at the third end, and a fourth cross-sectional length greater than the third cross-sectional length at the fourth end, and is configured to receive one or more particular radiated signals of the one or more radiated signals from a particular intermediary waveguide of the one or more intermediary waveguides into the third end and couple the one or more particular radiated signals into a particular hollow waveguide of the one or more hollow waveguides from the fourth end.

Illustrative clause 30. The transmitter of illustrative clause 29, wherein the third cross-sectional length of each particular horn is equal to the second cross-sectional length of the particular intermediary waveguide configured to couple the one or more particular radiated signals into the particular horn.

Illustrative clause 31. The transmitter of illustrative clause 29, wherein each particular horn is configured to couple the one or more particular radiated signals into a particular hollow waveguide having a fifth cross-sectional length equal to the fourth cross-sectional length of the particular horn.

Illustrative clause 32. A transmitter, comprising: a client-side input configured to receive one or more baseband signals having client data encoded therein; transmitter circuitry configured to receive the one or more baseband signals from the client-side input and generate one or more antenna feed signals based on the one or more baseband signals; and one or more antennas configured to receive the one or more antenna feed signals from the transmitter circuitry, generate one or more radiated signals based on the one or more antenna feed signals, and couple the one or more radiated signals into one or more hollow waveguides, the one or more radiated signals being radiated electromagnetic waves configured for coherent detection and having one or more frequencies in a range between 300 Gigahertz (GHz) and 10 Terahertz (THz); wherein the one or more antennas include a patch antenna.

Illustrative clause 33. The transmitter of illustrative clause 32, wherein the one or more antennas include a patch antenna array having a pair of patch antennas.

Illustrative clause 34. The transmitter of illustrative clause 32, further comprising one or more horns, the one or more antennas being configured to couple the one or more radiated signals into the one or more horns, the one or more horns being configured to receive the one or more radiated signals from the one or more antennas and couple the one or more radiated signals into the one or more hollow waveguides.

Illustrative clause 35. The transmitter of illustrative clause 34, wherein each particular horn of the one or more horns has a first end, a second end, a first cross-sectional length at the first end, and a second cross-sectional length greater than the first cross-sectional length at the second end, and is configured to receive one or more particular radiated signals of the one or more radiated signals from a particular antenna of the one or more antennas into the first end and couple the one or more particular radiated signals into a particular hollow waveguide of the one or more hollow waveguides from the second end.

Illustrative clause 36. A transmitter, comprising: a client-side input configured to receive one or more baseband signals having client data encoded therein; transmitter circuitry configured to receive the one or more baseband signals from the client-side input and generate one or more antenna feed signals based on the one or more baseband signals; and one or more antennas configured to receive the one or more antenna feed signals from the transmitter circuitry, generate one or more radiated signals based on the one or more antenna feed signals, and couple the one or more radiated signals into one or more hollow waveguides, the one or more radiated signals being radiated electromagnetic waves configured for coherent detection and having one or more frequencies in a range between 300 Gigahertz (GHz) and 10 Terahertz (THz); wherein the one or more antennas include a slot antenna.

Illustrative clause 37. The transmitter of illustrative clause 36, wherein the slot antenna is a double slot antenna having a pair of slots.

Illustrative clause 38. A receiver, comprising: one or more antennas configured to detect one or more radiated signals received from one or more hollow waveguides and generate one or more antenna output signals based on the one or more radiated signals, the one or more radiated signals being radiated electromagnetic waves being configured for coherent detection and having client data encoded therein and one or more frequencies in a range between 300 Gigahertz (GHz) and 10 Terahertz (THz); receiver circuitry configured to receive the one or more antenna output signals from the one or more antennas and generate one or more baseband signals based on the one or more antenna output signals; and a client-side output configured to receive the one or more baseband signals from the receiver circuitry and transmit the one or more baseband signals; wherein the one or more antennas include a helical antenna.

Illustrative clause 39. The receiver of illustrative clause 38, wherein the helical antenna is a bifilar helical antenna having a pair of wires.

Illustrative clause 40. The receiver of illustrative clause 39, wherein each particular wire of the pair of wires of the helical antenna has a plurality of coils including a first coil and a second coil, the first coil of each particular wire having a first characteristic dimension, the second coil of each particular wire having a second characteristic dimension different from the first characteristic dimension of the particular wire.

Illustrative clause 41. The receiver of illustrative clause 40, wherein the plurality of coils of each particular wire further includes a third coil, the first coil of each particular wire is adjacent to the second coil of the particular wire, and the second coil of each particular wire is adjacent to the third coil of the particular wire, the first characteristic dimension of the first coil of each particular wire being a first pitch measured between the first coil of the particular wire and the second coil of the particular wire, the second characteristic dimension of the second coil of each particular wire being a second pitch measured between the second coil of the particular wire and the third coil of the particular wire.

Illustrative clause 42. The receiver of illustrative clause 40, wherein the first characteristic dimension of the first coil of each particular wire is a first diameter of the first coil of the particular wire and the second characteristic dimension of the second coil of each particular wire is a second diameter of the second coil of the particular wire.

Illustrative clause 43. The receiver of illustrative clause 38, wherein the helical antenna has a plurality of coils including a first coil and a second coil, the first coil of the helical antenna having a first characteristic dimension, the second coil of the helical antenna having a second characteristic dimension different from the first characteristic dimension.

Illustrative clause 44. The receiver of illustrative clause 43, wherein the plurality of coils of the helical antenna further includes a third coil, the first coil of the helical antenna is adjacent to the second coil of the helical antenna, and the second coil of the helical antenna is adjacent to the third coil of the helical antenna, the first characteristic dimension of the first coil of the helical antenna being a first pitch measured between the first coil of the helical antenna and the second coil of the helical antenna, the second characteristic dimension of the second coil of the helical antenna being a second pitch measured between the second coil of the helical antenna and the third coil of the helical antenna.

Illustrative clause 45. The receiver of illustrative clause 43, wherein the first characteristic dimension of the first coil of the helical antenna is a first diameter of the first coil of the helical antenna and the second characteristic dimension of the second coil of the helical antenna is a second diameter of the second coil of the helical antenna.

Illustrative clause 46. The receiver of illustrative clause 38, wherein the helical antenna of the one or more antennas has a conductive cone surrounding the helical antenna.

Illustrative clause 47. A receiver, comprising: one or more antennas configured to detect one or more radiated signals received from one or more hollow waveguides and generate one or more antenna output signals based on the one or more radiated signals, the one or more radiated signals being radiated electromagnetic waves being configured for coherent detection and having client data encoded therein and one or more frequencies in a range between 300 Gigahertz (GHz) and 10 Terahertz (THz); receiver circuitry configured to receive the one or more antenna output signals from the one or more antennas and generate one or more baseband signals based on the one or more antenna output signals; and a client-side output configured to receive the one or more baseband signals from the receiver circuitry and transmit the one or more baseband signals; wherein the one or more antennas include a waveguide probe antenna.

Illustrative clause 48. The receiver of illustrative clause 47, wherein the waveguide probe antenna is a differential waveguide probe antenna having a pair of waveguide probes.

Illustrative clause 49. The receiver of illustrative clause 48, wherein the pair of waveguide probes of the waveguide probe antenna includes a first waveguide probe and a second waveguide probe configured to be positioned on opposite sides of a particular hollow waveguide of the one or more hollow waveguides.

Illustrative clause 50. The receiver of illustrative clause 48, further comprising one or more intermediary waveguides configured to receive the one or more radiated signals from the one or more hollow waveguides and guide the one or more radiated signals to the one or more antennas, the one or more antennas being configured to detect the one or more radiated signals received from the one or more intermediary waveguides.

Illustrative clause 51. The receiver of illustrative clause 50, wherein the waveguide probe antenna is a differential waveguide probe antenna having a pair of waveguide probes.

Illustrative clause 52. The receiver of illustrative clause 51, wherein the pair of waveguide probes of the waveguide probe antenna includes a first waveguide probe and a second waveguide probe configured to be positioned on opposite sides of a particular intermediary waveguide of the one or more intermediary waveguides.

Illustrative clause 53. The receiver of illustrative clause 50, wherein each particular intermediary waveguide of the one or more intermediary waveguides has a cross-sectional length greater than half of a maximum wavelength corresponding to a minimum frequency of the one or more frequencies of the one or more radiated signals and less than two of a minimum wavelength corresponding to a maximum frequency of the one or more frequencies of the one or more radiated signals.

Illustrative clause 54. The receiver of illustrative clause 53, wherein the cross-sectional length of each particular intermediary waveguide is a first cross-sectional length of the particular intermediary waveguide, each particular intermediary waveguide further having a first end, a second end, and a second cross-sectional length, and being configured to receive one or more particular radiated signals of the one or more radiated signals from a particular hollow waveguide of the one or more hollow waveguides into the first end and couple the one or more particular radiated signals into a particular hollow waveguide of the one or more hollow waveguides from the second end, each particular intermediary waveguide further having a flared end at the first end, the flared end of each particular intermediary waveguide having a second cross-sectional length greater than the first cross-sectional length.

Illustrative clause 55. The receiver of illustrative clause 54, further comprising one or more horns configured to receive the one or more radiated signals from the one or more hollow waveguides and couple the one or more radiated signals into the one or more intermediary waveguides, the one or more intermediary waveguides being configured to receive the one or more radiated signals from the one or more horns.

Illustrative clause 56. The receiver of illustrative clause 55, wherein each particular horn of the one or more horns has a third end, a fourth end, a third cross-sectional length at the third end, and a fourth cross-sectional length less than the third cross-sectional length at the fourth end, and is configured to receive one or more particular radiated signals of the one or more radiated signals from a particular hollow waveguide of the one or more hollow waveguides into the third end and couple the one or more particular radiated signals into a particular intermediary waveguide of the one or more intermediary waveguides from the fourth end.

Illustrative clause 57. The receiver of illustrative clause 56, wherein the third cross-sectional length of each particular horn is equal to the second cross-sectional length of the particular hollow waveguide from which the particular horn is configured to receive the one or more particular radiated signals.

Illustrative clause 58. The receiver of illustrative clause 56, wherein each particular horn is configured to couple the one or more particular radiated signals into a particular intermediary waveguide having a fifth cross-sectional length equal to the fourth cross-sectional length of the particular horn.

Illustrative clause 59. A receiver, comprising: one or more antennas configured to detect one or more radiated signals received from one or more hollow waveguides and generate one or more antenna output signals based on the one or more radiated signals, the one or more radiated signals being radiated electromagnetic waves being configured for coherent detection and having client data encoded therein and one or more frequencies in a range between 300 Gigahertz (GHz) and 10 Terahertz (THz); receiver circuitry configured to receive the one or more antenna output signals from the one or more antennas and generate one or more baseband signals based on the one or more antenna output signals; and a client-side output configured to receive the one or more baseband signals from the receiver circuitry and transmit the one or more baseband signals; wherein the one or more antennas include a tapered antenna.

Illustrative clause 60. The receiver of illustrative clause 59, wherein the tapered antenna is a differential tapered antenna having a pair of conductors.

Illustrative clause 61. The receiver of illustrative clause 60, wherein the pair of conductors of the tapered antenna includes a first conductor and a second conductor collectively defining an intermediary waveguide of one or more intermediary waveguides between the first conductor and the second conductor, the one or more intermediary waveguides being configured to receive the one or more radiated signals from the one or more hollow waveguides and guide the one or more radiated signals to the one or more antennas, the one or more antennas being configured to detect the one or more radiated signals received from the one or more intermediary waveguides.

Illustrative clause 62. The receiver of illustrative clause 61, wherein each particular intermediary waveguide of the one or more intermediary waveguides has a cross-sectional length greater than half of a maximum wavelength corresponding to a minimum frequency of the one or more frequencies of the one or more radiated signals and less than two of a minimum wavelength corresponding to a maximum frequency of the one or more frequencies of the one or more radiated signals.

Illustrative clause 63. The receiver of illustrative clause 62, wherein the cross-sectional length of each particular intermediary waveguide is a first cross-sectional length of the particular intermediary waveguide, each particular intermediary waveguide further having a first end, a second end, and a second cross-sectional length, and being configured to receive one or more particular radiated signals of the one or more radiated signals from a particular hollow waveguide of the one or more hollow waveguides into the first end and guide the one or more particular radiated signals into a particular antenna of the one or more antennas from the second end, each particular intermediary waveguide further having a flared end at the first end, the flared end of each particular intermediary waveguide having a second cross-sectional length greater than the first cross-sectional length.

Illustrative clause 64. The receiver of illustrative clause 63, further comprising one or more horns configured to receive the one or more radiated signals from the one or more hollow waveguides and couple the one or more radiated signals into the one or more intermediary waveguides, the one or more intermediary waveguides being configured to receive the one or more radiated signals from the one or more horns.

Illustrative clause 65. The receiver of illustrative clause 64, wherein each particular horn of the one or more horns has a third end, a fourth end, a third cross-sectional length at the third end, and a fourth cross-sectional length less than the third cross-sectional length at the fourth end, and is configured to receive one or more particular radiated signals of the one or more radiated signals from a particular hollow waveguide of the one or more hollow waveguides into the third end and couple the one or more particular radiated signals into a particular intermediary waveguide of the one or more intermediary waveguides from the fourth end.

Illustrative clause 66. The receiver of illustrative clause 65, wherein the third cross-sectional length of each particular horn is equal to the second cross-sectional length of the particular hollow waveguide from which the particular horn is configured to receive the one or more particular radiated signals.

Illustrative clause 67. The receiver of illustrative clause 66, wherein each particular horn is configured to couple the one or more particular radiated signals into a particular intermediary waveguide having a fifth cross-sectional length equal to the fourth cross-sectional length of the particular horn.

Illustrative clause 68. A receiver, comprising: one or more antennas configured to detect one or more radiated signals received from one or more hollow waveguides and generate one or more antenna output signals based on the one or more radiated signals, the one or more radiated signals being radiated electromagnetic waves being configured for coherent detection and having client data encoded therein and one or more frequencies in a range between 300 Gigahertz (GHz) and 10 Terahertz (THz); receiver circuitry configured to receive the one or more antenna output signals from the one or more antennas and generate one or more baseband signals based on the one or more antenna output signals; and a client-side output configured to receive the one or more baseband signals from the receiver circuitry and transmit the one or more baseband signals; wherein the one or more antennas include a patch antenna.

Illustrative clause 69. The receiver of illustrative clause 68, wherein the one or more antennas includes a patch antenna array having a pair of patch antennas.

Illustrative clause 70. The receiver of illustrative clause 68, further comprising one or more horns configured to receive the one or more radiated signals from the one or more hollow waveguides and guide the one or more radiated signals to the one or more antennas, the one or more antennas being configured to detect the one or more radiated signals received from the one or more horns.

Illustrative clause 71. The receiver of illustrative clause 70, wherein each particular horn of the one or more horns has a first end, a second end, a first cross-sectional length at the first end, and a second cross-sectional length less than the first cross-sectional length at the second end, and is configured to receive one or more particular radiated signals of the one or more radiated signals from a particular hollow waveguide of the one or more hollow waveguides into the first end and guide the one or more particular radiated signals to a particular antenna of the one or more antennas from the second end.

Illustrative clause 72. The receiver of illustrative clause 71, wherein the first cross-sectional length of each particular horn is equal to a third cross-sectional length of the particular hollow waveguide from which the particular horn is configured to receive the one or more particular radiated signals.

Illustrative clause 73. A receiver, comprising: one or more antennas configured to detect one or more radiated signals received from one or more hollow waveguides and generate one or more antenna output signals based on the one or more radiated signals, the one or more radiated signals being radiated electromagnetic waves being configured for coherent detection and having client data encoded therein and one or more frequencies in a range between 300 Gigahertz (GHz) and 10 Terahertz (THz); receiver circuitry configured to receive the one or more antenna output signals from the one or more antennas and generate one or more baseband signals based on the one or more antenna output signals; and a client-side output configured to receive the one or more baseband signals from the receiver circuitry and transmit the one or more baseband signals; wherein the one or more antennas include a slot antenna.

Illustrative clause 74. The receiver of illustrative clause 73, wherein the slot antenna is a double slot antenna having a pair of slots.

### CONCLUSION

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred embodiment. Further, the phrase “based on” is intended to mean “based, at least in part, on” unless explicitly stated otherwise.

1. A transmitter, comprising:
a client-side input configured to receive one or more baseband signals having client data encoded therein;
transmitter circuitry configured to receive the one or more baseband signals from the client-side input and generate one or more antenna feed signals based on the one or more baseband signals; and
one or more antennas configured to receive the one or more antenna feed signals from the transmitter circuitry, generate one or more radiated signals based on the one or more antenna feed signals, and couple the one or more radiated signals into one or more hollow waveguides, the one or more radiated signals being radiated electromagnetic waves configured for coherent detection and having one or more frequencies in a range between 300 Gigahertz (GHz) and 10 Terahertz (THz);
wherein the one or more antennas include a helical antenna.

2. The transmitter of claim 1, wherein the helical antenna is a bifilar helical antenna having a pair of wires.

3. The transmitter of claim 2, wherein each particular wire of the pair of wires of the helical antenna has a plurality of coils including a first coil and a second coil, the first coil of each particular wire having a first characteristic dimension, the second coil of each particular wire having a second characteristic dimension different from the first characteristic dimension of the particular wire.

4. The transmitter of claim 3, wherein the plurality of coils of each particular wire further includes a third coil, the first coil of each particular wire is adjacent to the second coil of the particular wire, and the second coil of each particular wire is adjacent to the third coil of the particular wire, the first characteristic dimension of the first coil of each particular wire being a first pitch measured between the first coil of the particular wire and the second coil of the particular wire, the second characteristic dimension of the second coil of each particular wire being a second pitch measured between the second coil of the particular wire and the third coil of the particular wire.

5. The transmitter of claim 3, wherein the first characteristic dimension of the first coil of each particular wire is a first diameter of the first coil of the particular wire and the second characteristic dimension of the second coil of each particular wire is a second diameter of the second coil of the particular wire.

6. The transmitter of claim 1, wherein the helical antenna has a plurality of coils including a first coil and a second coil, the first coil of the helical antenna having a first characteristic dimension, the second coil of the helical antenna having a second characteristic dimension different from the first characteristic dimension.

7. The transmitter of claim 6, wherein the plurality of coils of the helical antenna further includes a third coil, the first coil of the helical antenna is adjacent to the second coil of the helical antenna, and the second coil of the helical antenna is adjacent to the third coil of the helical antenna, the first characteristic dimension of the first coil of the helical antenna being a first pitch measured between the first coil of the helical antenna and the second coil of the helical antenna, the second characteristic dimension of the second coil of the helical antenna being a second pitch measured between the second coil of the helical antenna and the third coil of the helical antenna.

8. The transmitter of claim 6, wherein the first characteristic dimension of the first coil of the helical antenna is a first diameter of the first coil of the helical antenna and the second characteristic dimension of the second coil of the helical antenna is a second diameter of the second coil of the helical antenna.

9. The transmitter of claim 1, wherein the helical antenna of the one or more antennas has a conductive cone surrounding the helical antenna.

10. A transmitter, comprising:
a client-side input configured to receive one or more baseband signals having client data encoded therein;
transmitter circuitry configured to receive the one or more baseband signals from the client-side input and generate one or more antenna feed signals based on the one or more baseband signals; and
one or more antennas configured to receive the one or more antenna feed signals from the transmitter circuitry, generate one or more radiated signals based on the one or more antenna feed signals, and couple the one or more radiated signals into one or more hollow waveguides, the one or more radiated signals being radiated electromagnetic waves configured for coherent detection and having one or more frequencies in a range between 300 Gigahertz (GHz) and 10 Terahertz (THz);
wherein the one or more antennas include a waveguide probe antenna.

11. The transmitter of claim 10, wherein the waveguide probe antenna is a differential waveguide probe antenna having a pair of waveguide probes.

12. The transmitter of claim 11, wherein the pair of waveguide probes of the waveguide probe antenna includes a first waveguide probe and a second waveguide probe configured to be positioned on opposite sides of a particular hollow waveguide of the one or more hollow waveguides.

13. The transmitter of claim 11, further comprising one or more intermediary waveguides, the one or more antennas being configured to couple the one or more radiated signals into the one or more intermediary waveguides, the one or more intermediary waveguides being configured to receive the one or more radiated signals from the one or more antennas and couple the one or more radiated signals into the one or more hollow waveguides.

14. The transmitter of claim 13, wherein the waveguide probe antenna is a differential waveguide probe antenna having a pair of waveguide probes.

15. The transmitter of claim 14, wherein the pair of waveguide probes of the waveguide probe antenna includes a first waveguide probe and a second waveguide probe configured to be positioned on opposite sides of a particular intermediary waveguide of the one or more intermediary waveguides.

16. The transmitter of claim 13, wherein each particular intermediary waveguide of the one or more intermediary waveguides has a cross-sectional length greater than half of a maximum wavelength corresponding to a minimum frequency of the one or more frequencies of the one or more radiated signals and less than two of a minimum wavelength corresponding to a maximum frequency of the one or more frequencies of the one or more radiated signals.

17. The transmitter of claim 16, wherein the cross-sectional length of each particular intermediary waveguide is a first cross-sectional length of the particular intermediary waveguide, each particular intermediary waveguide further having a first end, a second end, and a second cross-sectional length, and being configured to receive one or more particular radiated signals of the one or more radiated signals from a particular antenna of the one or more antennas into the first end and couple the one or more particular radiated signals into a particular hollow waveguide of the one or more hollow waveguides from the second end, each particular intermediary waveguide further having a flared end at the second end, the flared end of each particular intermediary waveguide having a second cross-sectional length greater than the first cross-sectional length.

18. The transmitter of claim 17, further comprising one or more horns, the one or more intermediary waveguides being configured to couple the one or more radiated signals into the one or more horns, the one or more horns being configured to receive the one or more radiated signals from the one or more intermediary waveguides and couple the one or more radiated signals into the one or more hollow waveguides.

19. The transmitter of claim 18, wherein each particular horn of the one or more horns has a third end, a fourth end, a third cross-sectional length at the third end, and a fourth cross-sectional length greater than the third cross-sectional length at the fourth end, and is configured to receive one or more particular radiated signals of the one or more radiated signals from a particular intermediary waveguide of the one or more intermediary waveguides into the third end and couple the one or more particular radiated signals into a particular hollow waveguide of the one or more hollow waveguides from the fourth end.

20. The transmitter of claim 19, wherein the third cross-sectional length of each particular horn is equal to the second cross-sectional length of the particular intermediary waveguide configured to couple the one or more particular radiated signals into the particular horn.

21. The transmitter of claim 19, wherein each particular horn is configured to couple the one or more particular radiated signals into a particular hollow waveguide having a fifth cross-sectional length equal to the fourth cross-sectional length of the particular horn.

22. A transmitter, comprising:
a client-side input configured to receive one or more baseband signals having client data encoded therein;
transmitter circuitry configured to receive the one or more baseband signals from the client-side input and generate one or more antenna feed signals based on the one or more baseband signals; and
one or more antennas configured to receive the one or more antenna feed signals from the transmitter circuitry, generate one or more radiated signals based on the one or more antenna feed signals, and couple the one or more radiated signals into one or more hollow waveguides, the one or more radiated signals being radiated electromagnetic waves configured for coherent detection and having one or more frequencies in a range between 300 Gigahertz (GHz) and 10 Terahertz (THz);
wherein the one or more antennas include a tapered antenna.

23. The transmitter of claim 22, further comprising one or more intermediary waveguides, the one or more antennas being configured to couple the one or more radiated signals into the one or more intermediary waveguides, the one or more intermediary waveguides being configured to receive the one or more radiated signals from the one or more antennas and couple the one or more radiated signals into the one or more hollow waveguides.

24. The transmitter of claim 23, wherein the tapered antenna is a differential tapered antenna having a pair of conductors.

25. The transmitter of claim 24, wherein the pair of conductors of the tapered antenna includes a first conductor and a second conductor configured to be positioned on opposite sides of a particular intermediary waveguide of the one or more intermediary waveguides.

26. The transmitter of claim 23, wherein each particular intermediary waveguide of the one or more intermediary waveguides has a cross-sectional length greater than half of a maximum wavelength corresponding to a minimum frequency of the one or more frequencies of the one or more radiated signals and less than two of a minimum wavelength corresponding to a maximum frequency of the one or more frequencies of the one or more radiated signals.

27. The transmitter of claim 26, wherein the cross-sectional length of each particular intermediary waveguide is a first cross-sectional length of the particular intermediary waveguide, each particular intermediary waveguide further having a first end, a second end, and a second cross-sectional length, and being configured to receive one or more particular radiated signals of the one or more radiated signals from a particular antenna of the one or more antennas into the first end and couple the one or more particular radiated signals into a particular hollow waveguide of the one or more hollow waveguides from the second end, each particular intermediary waveguide further having a flared end at the second end, the flared end of each particular intermediary waveguide having a second cross-sectional length greater than the first cross-sectional length.

28. The transmitter of claim 27, further comprising one or more horns, the one or more intermediary waveguides being configured to couple the one or more radiated signals into the one or more horns, the one or more horns being configured to receive the one or more radiated signals from the one or more intermediary waveguides and couple the one or more radiated signals into the one or more hollow waveguides.

29. The transmitter of claim 28, wherein each particular horn of the one or more horns has a third end, a fourth end, a third cross-sectional length at the third end, and a fourth cross-sectional length greater than the third cross-sectional length at the fourth end, and is configured to receive one or more particular radiated signals of the one or more radiated signals from a particular intermediary waveguide of the one or more intermediary waveguides into the third end and couple the one or more particular radiated signals into a particular hollow waveguide of the one or more hollow waveguides from the fourth end.

30. The transmitter of claim 29, wherein the third cross-sectional length of each particular horn is equal to the second cross-sectional length of the particular intermediary waveguide configured to couple the one or more particular radiated signals into the particular horn.

31. The transmitter of claim 29, wherein each particular horn is configured to couple the one or more particular radiated signals into a particular hollow waveguide having a fifth cross-sectional length equal to the fourth cross-sectional length of the particular horn.

32. A transmitter, comprising:
a client-side input configured to receive one or more baseband signals having client data encoded therein;
transmitter circuitry configured to receive the one or more baseband signals from the client-side input and generate one or more antenna feed signals based on the one or more baseband signals; and
one or more antennas configured to receive the one or more antenna feed signals from the transmitter circuitry, generate one or more radiated signals based on the one or more antenna feed signals, and couple the one or more radiated signals into one or more hollow waveguides, the one or more radiated signals being radiated electromagnetic waves configured for coherent detection and having one or more frequencies in a range between 300 Gigahertz (GHz) and 10 Terahertz (THz);
wherein the one or more antennas include a patch antenna.

33. The transmitter of claim 32, wherein the one or more antennas include a patch antenna array having a pair of patch antennas.

34. The transmitter of claim 32, further comprising one or more horns, the one or more antennas being configured to couple the one or more radiated signals into the one or more horns, the one or more horns being configured to receive the one or more radiated signals from the one or more antennas and couple the one or more radiated signals into the one or more hollow waveguides.

35. The transmitter of claim 34, wherein each particular horn of the one or more horns has a first end, a second end, a first cross-sectional length at the first end, and a second cross-sectional length greater than the first cross-sectional length at the second end, and is configured to receive one or more particular radiated signals of the one or more radiated signals from a particular antenna of the one or more antennas into the first end and couple the one or more particular radiated signals into a particular hollow waveguide of the one or more hollow waveguides from the second end.

36. A transmitter, comprising:
a client-side input configured to receive one or more baseband signals having client data encoded therein;
transmitter circuitry configured to receive the one or more baseband signals from the client-side input and generate one or more antenna feed signals based on the one or more baseband signals; and
one or more antennas configured to receive the one or more antenna feed signals from the transmitter circuitry, generate one or more radiated signals based on the one or more antenna feed signals, and couple the one or more radiated signals into one or more hollow waveguides, the one or more radiated signals being radiated electromagnetic waves configured for coherent detection and having one or more frequencies in a range between 300 Gigahertz (GHz) and 10 Terahertz (THz);
wherein the one or more antennas include a slot antenna.

37. The transmitter of claim 36, wherein the slot antenna is a double slot antenna having a pair of slots.

38.-74. (canceled)
